(19) United States
(12) Patent Application Publication
(10) Pub. No.: US 2026/0268857 A1
(43) Pub. Date: Sep. 10, 2026

(54) STAGE, DISPLAY DEVICE INCLUDING SAME, AND DISPLAY SYSTEM INCLUDING SAME

(71) Applicant: Samsung Display Co., Ltd., Yongin-si (KR)

(72) Inventors: Kyeong Min PARK, Yongin-si (KR); Kyung Bae KIM, Yongin-si (KR); Yeon Kyung KIM, Yongin-si (KR)

(21) Appl. No.: 19/410,518

(22) Filed: Dec. 5, 2025

(30) Foreign Application Priority Data
Mar. 5, 2025 (KR) 10-2025-0028404

(51) Int. Cl. G09G 3/3266; G09G 3/3233

(52) U.S. Cl. CPC G09G 3/3266; G09G 3/3233; G09G 2300/0819; G09G 2300/0852; G09G 2300/0861; G09G 2310/0286; G09G 2310/06; G09G 2320/02; G09G 2320/041

(57) ABSTRACT

A stage includes: a node control unit configured to control a voltage of a first control node and a voltage of a second control node in response to a first input signal, a second input signal, and a third input signal; a node maintaining unit configured to maintain a voltage of the first control node and a voltage of the second control node constant; and an output unit configured to supply, in response to a voltage of the first control node and a voltage of the second control node, a first gate voltage supplied to a first power supply terminal or a second gate voltage supplied to a second power supply terminal to an output terminal. A logic low level of each of the first input signal, the second input signal, and the third input signal may be greater than a voltage level of the second gate voltage.

### CROSS-REFERENCE TO RELATED APPLICATION

The present application claims priority to and the benefit of Korean Patent Application No. 10-2025-0028404, filed on March 5, 2025, in the Korean Intellectual Property Office, the entire disclosure of which is incorporated herein by reference.

### BACKGROUND

### 1. Field

Aspects of some embodiments of the present disclosure relate to a stage, display device including the same, and a display system including the same.

### 2. Description of the Related Art

With the development of information technology, the importance of display devices as a medium of connection between users and information has become increasingly important. In response, the use of display devices such as liquid crystal display devices and organic light emitting display devices is increasing.

More recently, head-mounted display devices (HMDs) have been developed. Head-mounted display devices are display devices that enable Virtual Reality (VR) or Augmented Reality (AR) that may be worn by users in the form of glasses or a helmet to create a focal point in the near field in front of the eyes. Drivers are required to control the signals provided to the pixels included in high-resolution panels applicable to head-mounted display devices.

The above information disclosed in this Background section is only for enhancement of understanding of the background and therefore the information discussed in this Background section does not necessarily constitute prior art.

### SUMMARY

Aspects of some embodiments of the present disclosure include a stage for controlling signals provided to pixels included in a high-resolution panel, a display device including the same, and a display system including the same.

A stage according to some embodiments of the present disclosure, including: a node control unit configured to control a voltage of a first control node and a voltage of a second control node in response to a first input signal, a second input signal, and a third input signal; a node maintaining unit configured to maintain a voltage of the first control node and a voltage of the second control node constant; and an output unit configured to supply, in response to a voltage of the first control node and a voltage of the second control node, a first gate voltage supplied to a first power supply terminal or a second gate voltage supplied to a second power supply terminal to an output terminal. According to some embodiments, a logic low level of each of the first input signal, the second input signal, and the third input signal is greater than a voltage level of the second gate voltage.

According to some embodiments, the output unit may include a pull-down transistor including a first electrode connected to the output terminal, a second electrode connected to the second power supply terminal, a gate electrode connected to the second control node, and a body electrode connected to the first electrode.

According to some embodiments, the node maintaining unit may include a first capacitor connected between the second control node and the output terminal.

According to some embodiments, the first input signal may be supplied to a first input terminal, the second input signal may be supplied to the output terminal, and the third input signal may be supplied to a third input terminal. According to some embodiments, the node control unit may include, a first transistor including a first electrode connected to the first input terminal, a second electrode connected to the second control node, and a gate electrode connected to the output terminal; a second transistor including a first electrode connected to a first node, a second electrode connected to the second input terminal, and a gate electrode connected to a second control node; a third transistor including a first electrode connected to the first node, a second electrode connected to the second power supply terminal, and a gate electrode connected to the second input terminal; a fourth transistor including a first electrode connected to a second electrode of the fifth transistor, a second electrode connected to the second control node, and a gate electrode connected to the third input terminal; a fifth transistor including a first electrode connected to the first power supply terminal, a second electrode connected to the first electrode of the fourth transistor, and a gate electrode connected to the first node; a sixth transistor including a first electrode connected to a second node, a second electrode connected to the third input terminal, and a gate electrode connected to the first node; a seventh transistor including a first electrode connected to the second node, a second electrode connected to the first control node, and a gate electrode connected to the third input terminal; and a second capacitor connected between the first node and the second node.

According to some embodiments, the node maintaining unit may further include, an eighth transistor including a first electrode connected to the first power supply terminal, a second electrode connected to the first control node, and a gate electrode connected to the second control node; and a third capacitor connected between the first power supply terminal and the first control node.

According to some embodiments, the output unit may further include, a pull-up transistor including a first electrode connected to the first power supply terminal, a second electrode connected to the output terminal, and a gate electrode connected to the first control node.

According to some embodiments, each of the first transistor to the eighth transistor, the pull-up transistor, and the pull-down transistor may be a MOSFET including a body electrode.

A display device, according to some embodiments of the disclosure, including sub-pixels connected to first sub-gate lines, second sub-gate lines, and emission control lines; a first sub-gate driver including a plurality of stages supplying a first sub-gate signal to the first sub-gate lines; a second sub-gate driver including a plurality of stages supplying a second sub-gate signal to the second sub-gate lines, in response to the first input signal, the second input signal, and the third input signal; and an emission driver including a plurality of stages supplying an emission control signal to the emission control lines. According to some embodiments, a logic low level of each of the first input signal, the second input signal, and the third input signal is greater than a voltage level of a second gate voltage supplied to the second sub-gate driver.

According to some embodiments, a first gate voltage supplied to the first sub-gate driver, the second sub-gate driver, and the emission driver may be same. According to some embodiments, a voltage level of a second gate voltage supplied to the first sub-gate driver and the emission driver may be greater than a voltage level of the second gate voltage supplied to the second sub-gate driver.

According to some embodiments, a logic low level of each of the first input signal, the second input signal, and the third input signal may be equal to a voltage level of a second gate voltage supplied to the first sub-gate driver and the emission driver.

According to some embodiments, each of the stages of the second sub-gate driver may include, a node control unit configured to control a voltage of a first control node and a voltage of a second control node in response to the first input signal, the second input signal, and the third input signal; a node maintaining unit configured to maintain a voltage of the first control node and a voltage of the second control node constant; and an output unit configured to supply, in response to a voltage of the first control node and a voltage of the second control node, a first gate voltage supplied to the first power supply terminal or a second gate voltage supplied to the second power supply terminal to an output terminal. According to some embodiments, the output unit may include a first pull-down transistor including a first electrode connected to the output terminal, a second electrode connected to the second power supply terminal, a gate electrode connected to the second control node, and a body electrode connected to the first electrode.

According to some embodiments, the node maintaining unit may include a first capacitor connected between the second control node and the output terminal.

According to some embodiments, each of the stages of the first sub-gate driver may include, a node control unit configured to control, in response to a first start signal, a first clock signal, and a second clock signal, a voltage of a first control node and a voltage of a second control node; and a second pull-down transistor including a first electrode connected to an output terminal from which the first sub-gate signal is output, a second electrode connected to an input terminal from which the first clock signal is supplied, a gate electrode connected to a second control node from which the first start signal is supplied, and a body electrode connected to the first electrode.

According to some embodiments, each of the stages of the emission driver may include, a node control unit configured to control, in response to an emission start signal, a first emission clock signal, and a second emission clock signal, a voltage of a first control node and a voltage of a second control node; and a third pull-down transistor including a first electrode connected to an output terminal from which the emission control signal is output, a second electrode connected to a power supply terminal from which the second gate voltage is supplied, a gate electrode connected to a second control node from which the emission start signal is supplied, and a body electrode connected to the first electrode.

According to some embodiments, the first input signal may be supplied to a first input terminal, the second input signal may be supplied to a second input terminal, and the third input signal may be supplied to a third input terminal. According to some embodiments, the node control unit may include, a first transistor including a first electrode connected to the first input terminal, a second electrode connected to the second control node, and a gate electrode connected to the second input terminal; a second transistor including a first electrode connected to a first node, a second electrode connected to the second input terminal, and a gate electrode connected to a second control node; a third transistor including a first electrode connected to the first node, a second electrode connected to the second power supply terminal, and a gate electrode connected to the second input terminal; a fourth transistor including a first electrode connected to a second electrode of a fifth transistor, a second electrode connected to the second control node, and a gate electrode connected to the third input terminal; the fifth transistor including a first electrode connected to the first power supply terminal, a second electrode connected to the first electrode of the fourth transistor, and a gate electrode connected to the first node; a sixth transistor including a first electrode connected to a second node, a second electrode connected to the third input terminal, and a gate electrode connected to the first node; a seventh transistor including a first electrode connected to the second node, a second electrode connected to the first control node, and a gate electrode connected to the third input terminal; and a second capacitor connected between the first node and the second node.

According to some embodiments, the node maintaining unit may further include, an eighth transistor including a first electrode connected to the first power supply terminal, a second electrode connected to the first control node, and a gate electrode connected to the second control node; and a third capacitor connected between the first power supply terminal and the first control node.

According to some embodiments, the output unit may further include, a pull-up transistor including a first electrode connected to the first power supply terminal, a second electrode connected to the output terminal, and a gate electrode connected to the first control node.

According to some embodiments, each of the first transistor to the eighth transistor, the pull-up transistor, and the first pull-down transistor may be a MOSFET including a body electrode.

A display system according to some embodiments of the disclosure includes, a processor configured to output image data and a control signal; a display device configured to display an image based on the image data and the control signal. According to some embodiments, the display device includes: sub-pixels connected to first sub-gate lines, second sub-gate lines, and emission control lines; a first sub-gate driver including a plurality of stages supplying a first sub-gate signal to the first sub-gate lines; a second sub-gate driver including a plurality of stages supplying a second sub-gate signal to the second sub-gate lines in response to the first input signal, the second input signal, and the third input signal; and an emission driver including a plurality of stages supplying an emission control signal to the emission control lines. According to some embodiments, a logic low level of each of the first input signal, the second input signal, and the third input signal is greater than a voltage level of a second gate voltage supplied to the second sub-gate driver.

According to some embodiments, each of the stages of the second sub-gate driver may include, a node control unit configured to control a voltage of a first control node and a voltage of a second control node in response to the first input signal, the second input signal, and the third input signal; a node maintaining unit configured to maintain a voltage of the first control node and a voltage of the second control node constant; and an output unit configured to supply, in response to a voltage of the first control node and a voltage of the second control node, a first gate voltage supplied to a first power supply terminal or a second gate voltage supplied to a second power supply terminal to an output terminal. According to some embodiments, the output unit may include a pull-down transistor including a first electrode connected to the output terminal, a second electrode connected to the second power supply terminal, a gate electrode connected to the second control node, and a body electrode connected to the first electrode.

### BRIEF DESCRIPTION OF THE DRAWINGS

The above and other features of embodiments according to the present disclosure will become more apparent by describing in further detail aspects of some embodiments thereof with reference to the accompanying drawings, in which:

FIG. 1 is a diagram illustrating a transistor according to some embodiments of the present disclosure.

FIG. 2 is a block diagram illustrating a display device according to some embodiments of the present disclosure.

FIG. 3 is a block diagram illustrating further details of any one of the sub-pixels of FIG. 2.

FIG. 4 is a schematic diagram illustrating further details of the sub-pixel of FIG. 3.

FIG. 5 is a block diagram illustrating further details of the gate driver and voltage generator shown in FIG. 2.

FIG. 6 is a block diagram illustrating further details of the first sub-gate driver of FIG. 5.

FIG. 7 illustrates the stage shown in FIG. 6.

FIG. 8 is a waveform diagram representing one example of measured signals at the first stage of FIG. 7.

FIG. 9 is a block diagram illustrating further details of the emission driver of FIG. 5.

FIG. 10 illustrates the stage shown in FIG. 9.

FIG. 11 is a block diagram illustrating further details of the second sub-gate driver of FIG. 5.

FIG. 12 illustrates the stage shown in FIG. 11.

FIG. 13 is a waveform diagram illustrating aspects of measured signals at the first stage of FIG. 12.

FIGS. 14 through 16 are circuit diagrams illustrating operation of the first stage in response to the signals of FIG. 13.

FIG. 17 is a block diagram illustrating further details of the display system.

FIG. 18 is a perspective view showing further details of the display system of FIG. 17.

FIG. 19 is a diagram illustrating a head-mounted display device worn on the user of FIG. 18.

FIG. 20 is a block diagram of an electronic device, according to some embodiments of the present disclosure.

FIG. 21 is a schematic diagram of an electronic device according to some embodiments of the present disclosure.

### DETAILED DESCRIPTION

Hereinafter, with reference to the accompanying drawings, various embodiments of the disclosure will be described in detail to facilitate practice by one having ordinary skill in the art to which the disclosure belongs. The disclosure may be implemented in many different forms and is not limited to the embodiments described herein.

In the drawings, parts not pertinent to the disclosure have been omitted for clarity in the description of the disclosure, and like parts throughout the specification are designated by the same drawing designations.

Throughout the specification, when a part is the to be "connected" to another part, this includes not only when it is "directly connected" but also when it is "indirectly connected" with another element in between. The terms used herein are intended to describe specific embodiments and are not intended to limit the disclosure. Throughout the specification, when a part is the to "include" a component, it is meant to be inclusive of other components, not exclusive of other components, unless specifically noted to the contrary. "At least one of X, Y, and Z" and "at least one selected from the group consisting of X, Y, and Z" can be interpreted as one X, one Y, one Z, or any combination of two or more of X, Y, and Z (e.g., XYZ, XYY, YZ, ZZ). As used herein, "and/or" includes any combination of one or more of those configurations.

As used herein, terms such as first, second, and the like may be used to describe various components, but such components are not limited to such terms. These terms are used to distinguish one component from another. Thus, a first component may refer to a second component without departing from what is disclosed herein.

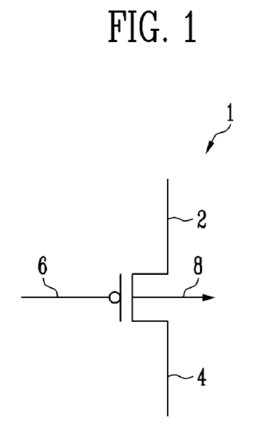

FIG. 1 is a diagram illustrating a transistor according to some embodiments of the present disclosure.

Referring to FIG. 1, the transistor 1 according to some embodiments of the present disclosure may include a first electrode 2, a second electrode 4, a gate electrode 6, and a body electrode 8. For example, the transistor 1 may be a metal-oxide-semiconductor field-effect transistor (MOSFET). The transistor 1 including the body electrode 8 (e.g., a MOSFET) may require a small mounting area and may be suitable for implementing a high-resolution pixel.

The transistor 1 may be formed on a silicon wafer. For example, a panel can be implemented by laminating a transistor layer, a light emitting layer, a cover layer, and the like on a silicon wafer. However, this is an example, and the transistor 1 can be formed on various substrates (e.g., glass substrates) currently known in the art.

A gate on voltage may be a voltage of a gate signal at which the transistor 1 may be turned on. The gate off voltage may be a voltage at which the transistor 1 may be turned off.

In a P-type transistor 1, the gate-on voltage may be a logic low level, and the gate-off voltage may be a logic high level. In an N-type transistor 1, the gate-on voltage may be a logic high-level, and the gate-off voltage may be a logic-low level.

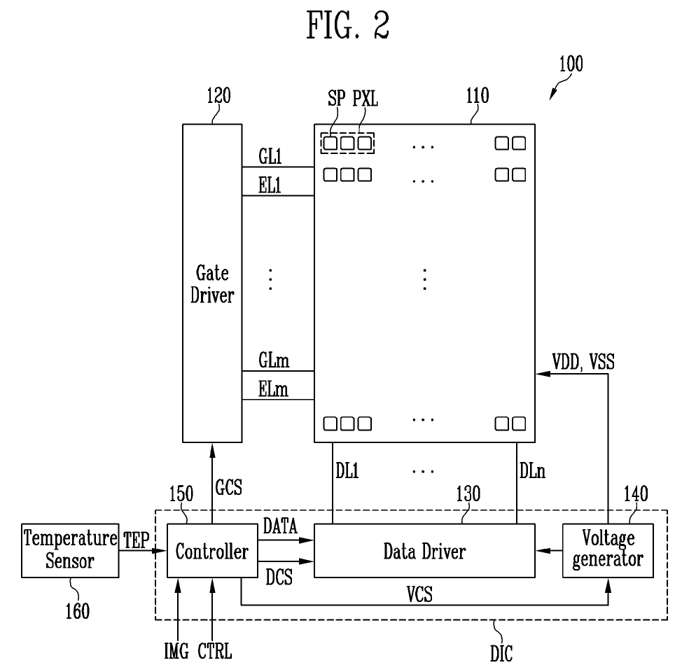

FIG. 2 is a block diagram illustrating a display device according to some embodiments of the present disclosure.

Referring to FIG. 2, the display device 100 may include a display panel 110, a gate driver 120, a data driver 130, a voltage generator 140, and a controller 150.

The display panel 110 includes sub-pixels SP. The sub-pixels SP may be connected to the gate driver 120 via first to m-th gate lines GL1 to GLm. The sub-pixels SP can be connected to the data driver 130 via first to n-th data lines DL1 to DLn.

Each of the sub-pixels SP may include at least one light emitting element configured to generate light. Accordingly, each of the sub-pixels SP may be capable of generating light of a particular color, such as red, green, blue, cyan, magenta, yellow, or the like. Two or more of the sub-pixels SP may form a single pixel PXL. For example, as shown in FIG. 2, three sub-pixels may form a single PXL.

The gate driver 120 is connected to the sub-pixels SP arranged in a row direction via the first to m gate lines GL1 to GLm. The gate driver 120 may output gate signals to the first to m-th gate lines GL1 to GLm in response to a gate control signal GCS. According to some embodiments, the gate control signal GCS may include a start signal to indicate the start of each frame, a horizontal synchronization signal to output the gate signals in synchronization with the timing of data signals being applied, and the like.

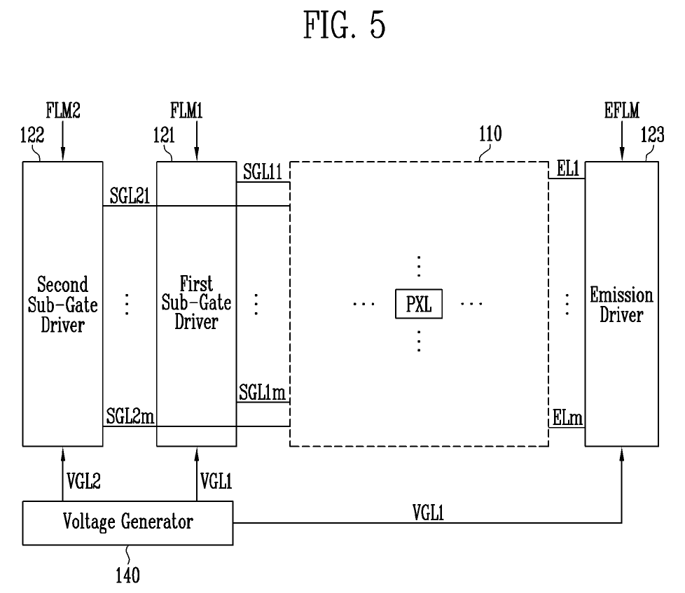

According to some embodiments, there may be further first to m-th emission control lines EL1 to ELm connected to sub-pixels SP in the row direction. In such cases, the gate driver 120 may include an emission driver configured to control the first to m-th emission control lines EL1 to ELm, and the emission driver may operate under control of the controller 150. A more detailed description of this will be provided later with reference to FIG. 5.

The gate driver 120 may be located on one side of the display panel 110. However, embodiments are not limited to this. For example, the gate driver 120 may be separated into two or more physically and/or logically distinct drivers, and such drivers may be located on one side of the display panel 110 and on a different side of the display panel 110 opposite the first side. As such, the gate driver 120 may be located around the periphery of the display panel 110 in various configurations according to some embodiments.

The data driver 130 is connected to the sub-pixels SP arranged in a column direction via the first to n-th data lines DL1 to DLn. The data driver 130 receives image data DATA and a data control signal DCS from the controller 150. The data driver 130 operates in response to the data control signal DCS. According to some embodiments, the data control signal DCS may include a source start pulse, a source shift clock, a source output enable signal, and the like.

Using voltages from the voltage generator 140, the data driver 130 may apply data signals having grayscale voltages corresponding to the image data DATA to the first to n-th data lines DL1 to DLn. When a gate signal is applied to each of the first to m-th gate lines GL1 to GLm, data signals corresponding to the image data DATA may be applied to the data lines DL1 to DLm. Accordingly, the corresponding sub-pixels SP may generate light corresponding to the data signals. Accordingly, an image is displayed on the display panel 110.

According to some embodiments, the gate driver 120 and the data driver 130 may include complementary metal-oxide semiconductor (CMOS) circuit elements.

The voltage generator 140 may be operated in response to a voltage control signal VCS from the controller 150. The voltage generator 140 is configured to generate a plurality of voltages and provide the generated voltages to components of the display device 100. For example, the voltage generator 140 may be configured to generate the plurality of voltages by receiving an input voltage from external to the display device 100, adjusting the received voltage, and regulating the adjusted voltage.

The voltage generator 140 may generate a first power supply voltage VDD and a second power supply voltage VSS, and the generated first and second power supply voltages VDD, VSS may be provided to the sub-pixels SP. The first power supply voltage VDD may have a higher voltage level relatively, and the second power supply voltage VSS may have a lower voltage level than the first power supply voltage VDD. According to some embodiments, the first power supply voltage VDD or the second power supply voltage VSS may be provided by an external device to the display device 100.

In addition, the voltage generator 140 can generate various voltages. For example, the voltage generator 140 may generate an initialization voltage that is applied to the sub-pixels SP. For example, in a sensing operation to sense electrical characteristics of transistors and/or light emitting elements of the sub-pixels SP, a selected reference voltage may be applied to the first to n-th data lines DL1 to DLn, and the voltage generator 140 may generate such a reference voltage.

The controller 150 controls various operations of the display device 100. The controller 150 receives input image data IMG and a control signal CTRL to control the display thereof from an external source. In response to the control signal CTRL, the controller 150 may provide a gate control signal GCS, a data control signal DCS, and a voltage control signal VCS.

The controller 150 may convert the input image data IMG to be suitable for the display device 100 or display panel 110 to output image data DATA. According to some embodiments, the controller 150 may output the image data DATA by aligning the input image data IMG to fit the sub-pixels SP in a unit of a row.

Two or more of the components of the data driver 130, voltage generator 140, and controller 150 may be mounted on a single integrated circuit. As shown in FIG. 2, the data driver 130, voltage generator 140, and controller 150 may be in a driver integrated circuit DIC. In such cases, the data driver 130, voltage generator 140, and controller 150 may be functionally distinct components within a single driver integrated circuit DIC. According to some embodiments, at least one of the data driver 130, voltage generator 140, or controller 150 may be provided as a component separate from the driver integrated circuit DIC.

The display device 100 may include at least one temperature sensor 160. The temperature sensor 160 is configured to sense a temperature in its vicinity and generate temperature data TEP indicative of the sensed temperature. According to some embodiments, the temperature sensor 160 may be located adjacent to the display panel 110 and/or the driver integrated circuit DIC.

The controller 150 may control various behaviors of the display device 100 in response to the temperature data TEP. According to some embodiments, the controller 150 may adjust the brightness of the image output from the display panel 110 in response to the temperature data TEP. For example, the controller 150 may regulate data signals and first and second power supply voltages VDD, VSS by controlling components such as the data driver 130 and/or the voltage generator 140.

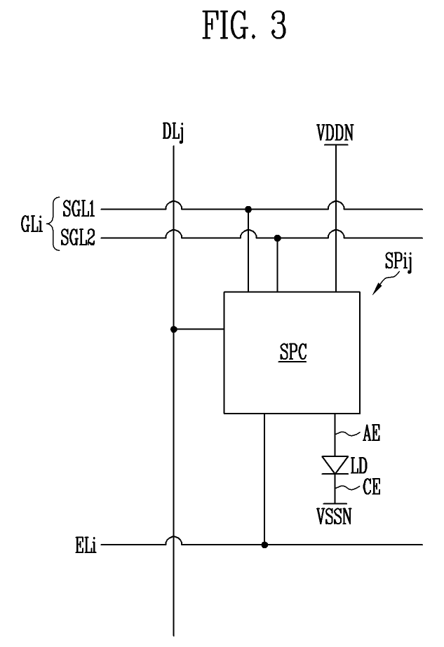

FIG. 3 is a block diagram illustrating further details of any one of the sub-pixels of FIG. 2. In FIG. 3, a sub-pixel SPij among the sub-pixels SPs of FIG. 2 arranged in row i (where i is an integer greater than or equal to 1 and less than or equal to m) and column j (where j is an integer greater than or equal to 1 and less than or equal to n) is shown in an example.

Referring to FIG. 3, the sub-pixel SPij may include a sub-pixel circuit SPC and a light emitting element LD.

The light emitting element LD is connected between the first power supply voltage node VDDN and the second power supply voltage node VSSN. The first power supply voltage node VDDN is the node transmitting the first power supply voltage VDD in FIG. 2, and the second power supply voltage node VSSN is the node transmitting the second power supply voltage VSS in FIG. 2.

The anode electrode AE of the light-emitting element LD may be connected to the first power supply voltage node VDDN via the sub-pixel circuit SPC, and the cathode electrode CE of the light-emitting element LD may be connected to the second power supply voltage node VSSN. For example, the anode electrode AE of the light emitting element LD may be connected to the first power supply voltage node VDDN via one or more transistors included in the sub pixel circuit SPC.

The sub-pixel circuit SPC may be connected to the i-th gate line GLi of the first to m-th gate lines GL1 to GLm of FIG. 2, the i-th emission control line ELi of the first to m-th emission control lines EL1 to ELm of FIG. 2, and the j-th data line DLj of the first to n-th data lines DL1 to DLn of FIG. 2. The sub-pixel circuit SPC is configured to control the light emitting element LD according to signals received via these signal lines.

The sub-pixel circuit SPC may operate in response to a gate signal received via the i-th gate line GLi. The i-th gate line GLi may include one or more sub-gate lines. According to some embodiments, as shown in FIG. 3, the i-th gate line GLi may include first and second sub-gate lines SGL1, SGL2. The sub-pixel circuit SPC may operate in response to gate signals received via the first and second sub-gate lines SGL1, SGL2. As such, when the i-th gate line GLi includes two or more sub-gate lines, the sub-pixel circuit SPC may operate in response to gate signals received through those sub-gate lines.

The sub-pixel circuit SPC may operate in response to an emission control signal received via the i-th emission control line ELi. According to some embodiments, the i-th emission control line ELi may include one or more sub-emission control lines. When the i-th emission control line ELi includes two or more sub-emission control lines, the sub-pixel circuit SPC may operate in response to emission control signals received via those sub-emission control lines.

The sub-pixel circuit SPC may receive the data signal via the j-th data line DLj. The sub-pixel circuit SPC may store a voltage corresponding to the data signal in response to at least one of the gate signals received via the first and second sub-gate lines SGL1, SGL2. In response to an emission control signal received via the i-th emission control line ELi, the sub pixel circuit SPC may regulate a current flowing from the first power supply voltage node VDDN to the second power supply voltage node VSSN via the light emitting element LD in accordance with the stored voltage. Accordingly, the light emitting element LD may generate light of a luminance corresponding to the data signal.

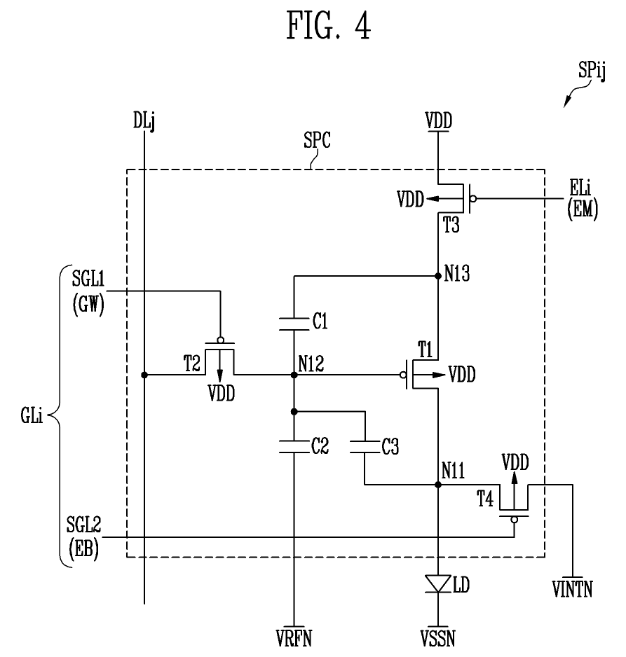

FIG. 4 is a schematic diagram illustrating further details of the sub-pixel of FIG. 3. Although FIG. 4 illustrates various components in a sub-pixel according to some embodiments, embodiments according to the present disclosure are not limited thereto, and according to various embodiments the sub-pixel may include additional components, or fewer components, without departing from the spirit and scope of embodiments according to the present disclosure.

Referring to FIG. 4, the sub-pixel SPij may include a sub-pixel circuit SPC and a light emitting element LD.

The sub-pixel circuit SPC may be connected to the i-th gate line GLi, the i-th emission control line ELi, and the j-th data line DLj.

The sub pixel circuit SPC may include first to fourth transistors T1 to T4, and first capacitor C1, second capacitor C2, and third capacitor C3.

The first transistor T1 is connected between the first supply voltage node VDDN and the first node N11. The gate of the first transistor T1 is connected to the second node N12, whereby the first transistor T1 may be turned on depending on the voltage level of the second node N12. The first transistor T1 may be referred to as a driving transistor.

The second transistor T2 is connected between the j-th data line DLj and the second node N12. The gate of the second transistor T2 is connected to the first sub-gate line SGL1, such that the second transistor T2 can be turned on in response to the first sub-gate signal GW of the first sub-gate line SGL1. The first sub-gate signal GW may control the timing at which the data signal delivered via the j-th data line DLj to the second node N12 is applied. The second transistor T2 may be referred to as a switching transistor.

The third transistor T3 is connected between the first power supply voltage node VDDN and the third node N13. The gate of the third transistor T3 is connected to the emission control line ELi, and accordingly, the third transistor T3 may be turned on in response to the emission control signal EM of the emission control line ELi. The emission control signal EM may control the timing at which the first power supply voltage node VDDN and the third node N13 are connected. According to some embodiments, the first transistor T1 may be connected between the third node N13 and the first node N11.

The fourth transistor T4 is connected between the first node N11 (i.e., the anode electrode of the light emitting element LD) and the initialization voltage node VINTN. The initialization voltage node VINTN is configured to deliver an initialization voltage. The initialization voltage may be less than the first power supply voltage and greater than the second power supply voltage.

According to some embodiments, the initialization voltage may be provided by the voltage generator 140 of FIG. 1. According to some embodiments, the initialization voltage may be provided by a device external to the display device 100.

According to some embodiments, the body electrodes of each of the first through fourth transistors T1 through T4 may be supplied with a first power supply voltage.

The gate of the fourth transistor T4 is connected to the second sub-gate line SGL2, whereby the fourth transistor T4 may be turned on in response to the second sub-gate signal EB of the second sub-gate line SGL2. The second sub-gate signal EB may control the timing of the connection of the initialization voltage node VINTN to the first node N1.

The first capacitor C1 is connected between the second node N12 and the third node N13. The second capacitor C2 is connected between the second node N12 and the reference voltage node VRFN. The reference voltage node VRFN is configured to deliver a reference voltage. The reference voltage may be less than the first power supply voltage and greater than the second power supply voltage.

According to some embodiments, the reference voltage may be provided by the voltage generator 140 of FIG. 1. A third capacitor C3 is connected between the first node N11 and the second node N12.

As such, the sub-pixel circuit SPC may include first to fourth transistors T1 to T4, and first to third capacitors C1, C2, and C3. However, embodiments are not limited to these.

The subpixel circuit SPC can be implemented as any of various types of circuits comprising a plurality of transistors and one or more capacitors. For example, the sub pixel circuit SPC may include two transistors and one capacitor. According to various embodiments of the sub pixel circuit SPC, the number of sub-gate lines included in the i-th gate line GLi and the number of sub-emission control lines included in the i-th emission control line ELi may be variable.

The first through fourth transistors T1 through T4 may be transistors of the P-type transistors described in FIG. 1. Each of the first to fourth transistors T1 to T4 may be a metal oxide silicon field effect transistor (MOSFET).

However, embodiments are not limited to this. For example, at least one of the first to fourth transistors T1 to T4 may be replaced by an N-type transistor.

The light emitting element LD may include an anode electrode, a cathode electrode, and a light emitting layer. The light emitting layer may be located between the anode electrode and the cathode electrode. After the data signal transmitted via the j-th data line DLj is reflected in the voltage of the second node N12, the third transistor T3 may be turned on when the emission control signal of the i-th emission control line ELi is enabled to a logic low level. Furthermore, the first transistor T1 may be turned on according to the voltage of the second node N12, and, accordingly, a current may flow from the first supply voltage node VDDN to the second supply voltage node VSSN. The light emitting element LD may emit light depending on the amount of current flowing.

FIG. 5 is a block diagram illustrating further details of the gate driver and voltage generator shown in FIG. 2.

Referring to FIGS. 4 and 5, the gate driver 120 of FIG. 2 may include a first sub-gate driver 121, a second sub-gate driver 122, and an emission control driver 123.

The first gate driver 121 may receive the first gate start signal FLM1 and generate the first sub-gate signal GW by shifting the first gate start signal FLM1 in response to a clock signal. The first gate driver 121 may sequentially supply the first sub-gate signal GW to the first sub-gate lines SGL11 to SGL1m.

The second gate driver 122 may receive the second gate start signal FLM2 and generate second sub-gate signal EB by shifting the second gate start signal FLM2 in response to a clock signal. The second gate driver 122 may sequentially supply the second sub-gate signal EB to the second sub-gate lines SGL21 to SGL2m.

The emission driver 123 may receive the emission start signal EFLM and may generate an emission control signal by shifting the emission start signal EFLM in response to a clock signal. The emission driver 123 may sequentially supply the emission control signal EM to the emission control lines EL1 to Elm.

The voltage generator 140 may supply a first low voltage VGL1 to the first sub-gate driver 121 and the emission driver 123 and supply a second low voltage VGL2 to the second sub-gate driver 122.

The first low voltage VGL1 may be a voltage at a logic low level of the first gate signal GW and the emission control signal EM. The second low voltage VGL2 may be a voltage at the logic low level of the second gate signal EB.

The first low voltage VGL1 can be greater than the second low voltage VGL2. The absolute value of the first low voltage VGL1 may be less than the absolute value of the second low voltage VGL2.

For example, the voltage level of the first low voltage VGL1 may be '-1.3V' and the voltage level of the second low voltage VGL2 may be '-4.6V'.

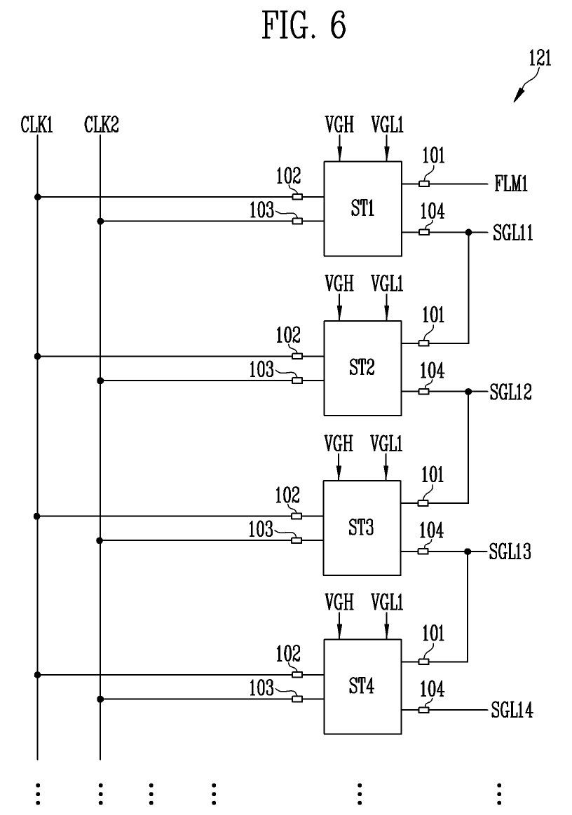

FIG. 6 is a block diagram illustrating further details of the first sub-gate driver of FIG. 5.

Referring to FIGS. 2 and 6, the first sub-gate driver 121 according to some embodiments of the present disclosure may include a plurality of stages STs for supplying respective first sub-gate signals to the plurality of first sub-gate lines SGL11 to SGL1m.

In accordance with embodiments, the first sub-gate driver 121 may include a plurality of stages ST dependently connected to an input terminal of the first start signal FLM1 (e.g., the first input terminal 101 of the first stage ST1), such as the first to fourth stages ST1 to ST4.

In FIG. 6, only four stages are shown, for example, the first to fourth stages ST1 to ST4.

The first to fourth stages ST1 to ST4 are coupled to any one of the first sub-gate lines SGL11 to SGL14 and may be driven in response to a first clock signal CLK1, a second clock signal CLK2.

The first to fourth stages ST1 to ST4 may sequentially output first sub-gate signals to the first sub-gate lines SGL11 to SGL14. According to some embodiments, the first to fourth stages ST1 to ST4 may have the same (or substantially the same) circuit structure as each other.

Each of the first to fourth stages ST1 to ST4 may include a first input terminal 101, an output terminal 104 102, a third input terminal 103, and an output terminal 104.

The first input terminal 101 may be supplied with a first input signal. According to some embodiments, the first input signal may be a first start signal FLM1 or an output signal of the previous stage (i.e., a first sub-gate signal of the previous stage).

For example, the first stage (hereinafter, referred to as "first stage (ST1)") may be supplied with a first start signal FLM1 via the first input terminal 101, and the remaining stages ST may be supplied with the output signal of the previous stage via their respective first input terminals 101.

The first start signal FLM1 may periodically have a second gate voltage VGL1. The second gate voltage VGL1 may refer to the first low voltage VGL1 described in FIG. 5.

The second input terminal 102 and the third input terminal 103 may be supplied with a second input signal and a third input signal, respectively. According to some embodiments, the second input signal may be the first clock signal CLK1 and the third input signal may be the second clock signal CLK2.

The first clock signal CLK1 and the second clock signal CLK2 may alternately have the second gate voltage VGL1. For example, the first clock signal CLK1 and the second clock signal CLK2 may be signals that have the same cycle period and phases thereof are not overlapped to each other. In one example, the second clock signal CLK2 may be a clock signal that is the first clock signal CLK1 shifted by half a cycle period.

Further, the first to fourth stages ST1 to ST4 may be operated by being supplied with the first gate voltage VGH and the second gate voltage VGL1. The first gate voltage VGH may be set to a gate-off voltage, e.g., a logic high level, and the second gate voltage VGL1 may be set to a gate-on voltage, e.g., a logic low level (when the pixels are formed with P-type transistors).

The first gate voltage (VGH) or second gate voltage (VGL1) delivered to the output terminal 104 may be utilized as the first sub-gate signal provided to the sub-pixels (SP) of FIG. 2.

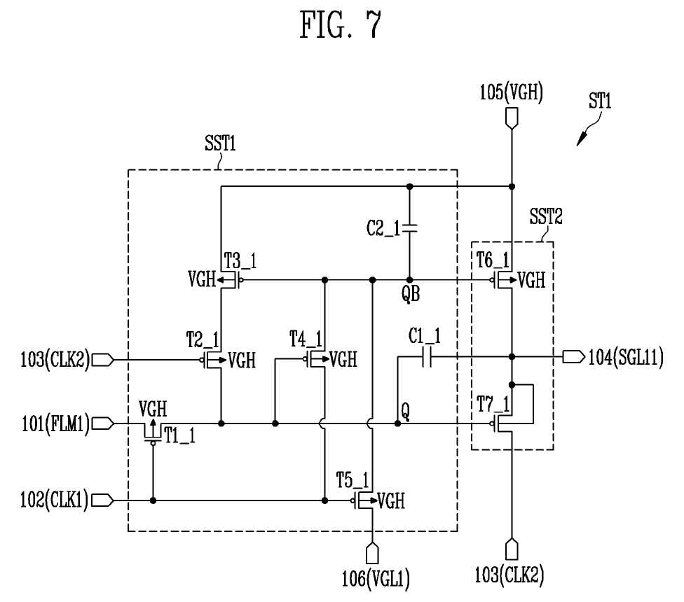

FIG. 7 illustrates the stage shown in FIG. 6. According to some embodiments, the plurality stages of the first sub-gate driver 121 may have the same (or substantially the same) circuit structure as each other. Accordingly, only the first stage ST1 is shown in FIG. 7 as representative of these stages. Although FIG. 7 illustrates various components in a stage according to some embodiments, embodiments according to the present disclosure are not limited thereto, and according to various embodiments the stage may include additional components, or fewer components, without departing from the spirit and scope of embodiments according to the present disclosure.

Referring to FIGS. 6 and 7, the first stage ST1 may include a node control unit (or node controller, or node control circuit, or node control component) SST1, and output unit (or outputter, or output circuit, or output component) SST2.

The first stage ST1 may generate a first sub-gate signal using the first to third input signals supplied via the first to third input terminals 101~103 and supply the generated first sub-gate signal to the output terminal 104.

Further, the first stage ST1 may be supplied with first and second gate voltages VGH, VGL1 via the first and second power supply terminals 105, 106, respectively. As such, the first stage ST1 may control the voltage at the output terminal 104 by using the first and second gate voltages VGH, VGL1 supplied to the first and second power supply terminals 105, 106.

The output unit SST2 is connected to the first power supply terminal 105 and the third input terminal 103, and the output unit SST2 may output to the output terminal 104 as a first sub-gate signal based on the voltage of the second control node Q.

The output unit SST2 may include a sixth transistor T6_1 (or, a pull-up transistor) and a seventh transistor T7_1 (or, a pull-down transistor).

The sixth transistor T6_1 may include a first electrode connected to the first power supply terminal 105, a second electrode connected to the output terminal 104, and a gate electrode connected to the first control node QB.

The seventh transistor T7_1 may include a first electrode connected to the output terminal 104, a second electrode connected to the third input terminal 103, and a gate electrode connected to the second control node Q.

Further, the first electrode of the seventh transistor T7_1 may be connected with the body electrode. As the voltage difference between the body electrode and the source electrode (i.e., the first electrode) of the seventh transistor T7_1 becomes smaller, the phenomenon of the threshold voltage of the seventh transistor T7_1 increasing may be prevented or reduced. In other words, the driving power of the seventh transistor T7_1 may be relatively improved. Accordingly, the operation accuracy of the first stage ST1 may be relatively improved, the reliability may be relatively improved, and the image quality of the display panel may be relatively improved.

The node control unit SST1 may be connected to the first input terminal 101, the second input terminal 102, the third input terminal 103, the first power supply terminal 105, and the second power supply terminal 106. The node control unit SST1 may control the voltage of the first control node QB and the voltage of the second control node Q by using the first start signal (FLM1; or the first sub-gate signal of the previous stage) provided via the first input terminal 101.

The node control unit SST1 may include first to fifth transistors T1_1 through T1_5, a first capacitor C1_1, and a second capacitor C2_1.

The first transistor T1_1 may include a first electrode connected to the first input terminal 101, a second electrode connected to the second control node Q, and a gate electrode connected to the second input terminal 102.

The second transistor T2_1 may include a first electrode connected to a second electrode of the third transistor T3_1, a second electrode connected to the second control node Q, and a gate electrode connected to the third input terminal 103.

The third transistor T3_1 may include a first electrode connected to the first power supply terminal 105, a second electrode connected to the first electrode of the second transistor T2_1, and a gate electrode connected to the first control node QB.

The fourth transistor T4_1 may include a first electrode connected to the first control node QB, a second electrode connected to the second input terminal 102, and a gate electrode connected to the second control node Q.

The fifth transistor T5_1 may include a first electrode connected to the first control node QB, a second electrode connected to the second power supply terminal 106, and a gate electrode connected to the second input terminal 102.

The first capacitor C1_1 may be connected between the second control node Q and the output terminal 104. The second capacitor C2_1 may be connected between the first power supply terminal 105 and the first control node QB.

A first gate voltage (VGH) may be applied to the body electrode of each of the first to sixth transistors T1_1 to T6_1. Each of the first to seventh transistors T1_1 to T7_1 may be a P-type transistor as described in FIG. 1. Furthermore, according to some embodiments, at least one of the first to seventh transistors T1_1 to T7_1 may be implemented as a dual gate transistor for relatively improved reliability.

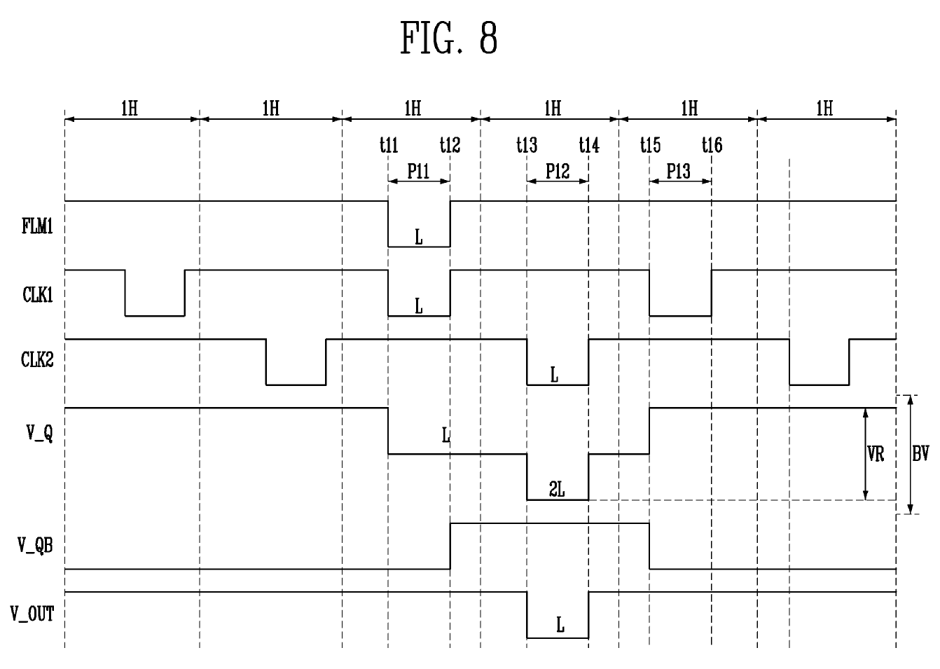

FIG. 8 is a waveform diagram representing one example of measured signals at the first stage of FIG. 7.

Referring to FIGS. 7 and 8, the measured signals at the first stage ST1 are shown. The first clock signal CLK1 applied to the second input terminal 102 has a cycle period of two horizontal periods 2H and may have a logic low level and a logic high level. Here, the logic low level may be equal to a voltage level of the second gate voltage VGL1 that turns on the P-type transistor. The second gate voltage VGL1 may refer to the first low voltage VGL1 shown in FIGS. 5 and 6. The logic high level may be equal to the level of the first gate voltage VGH that turns off the P-type transistor.

The second clock signal CLK2 applied to the third input terminal 103 may have a waveform such as the first clock signal CLK1 is delayed by half a cycle period (i.e., by one horizontal period 1H).

During the first period P11 between the first time point t11 and the second time point t12, the first start signal FLM1 and the first clock signal CLK1 may have a logic low level and the second clock signal CLK2 may have a logic high level.

When the first clock signal CLK1 has a logic low level, the first transistor T1_1 and the fifth transistor T5_1 may be turned on.

During the first period P11, the second node voltage V_Q at the second control node Q may have a logic low level as the first start signal FLM1 has a logic low level, and the first transistor T1_1 is turned on.

During the first period P11, as the fifth transistor T5_1 is turned on, the second gate voltage VGL1 provided to the second power supply terminal 106 is transferred to the first control node QB, so that the first node voltage V_QB at the first control node QB may have a logic low level.

Also, during the first period P11, as the first node voltage V_QB has a logic low level, the sixth transistor T6_1 is turned on, so that the first gate voltage VGH may be output to the output terminal 104. In other words, the output voltage V_OUT (i.e., the first sub-gate signal) at the output terminal 104 may have a logic high level.

During the second period P12 between the third time point t13 and the fourth time point t14, the first start signal FLM1 and the first clock signal CLK1 have a logic high level, and the second clock signal CLK2 may have a logic low level.

When the second clock signal CLK2 has a logic low level, the second transistor T2_1 may be turned on.

During the second period P12, the second node voltage V_Q at the second control node Q may be charge-boosted by the second transistor T22 and the first capacitor C1 to have a second logic low level. The second logic low level may have a value of twice the voltage level of the second gate voltage VGL1.

When the first low voltage VGL1 having an absolute value smaller than an absolute value of the second low voltage VGL2 is applied to the first sub-gate driver 121, the range VR of the voltage level of the second node voltage V_Q at the second control node Q may be smaller than when the second low voltage VGL2 is applied. Accordingly, the range VR of voltage levels of the second node voltage V_Q at the second control node Q may not be outside the limit range BV of the breakdown voltage of a transistor.

In other words, the reliability of the operation of the transistors connected to the second control node Q can be secured. As a result, the operation accuracy of the first stage ST1 may be relatively improved, the reliability may be relatively improved, and the image quality of the display panel including pixels may be relatively improved.

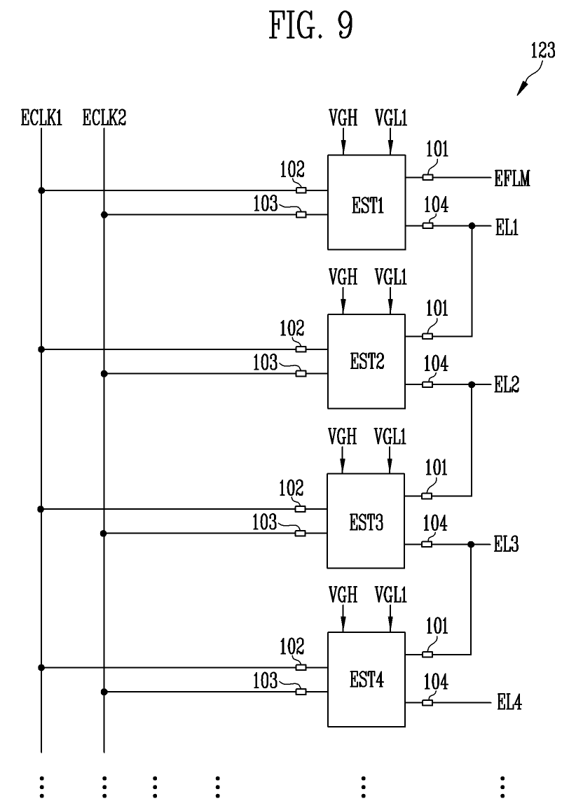

FIG. 9 is a block diagram illustrating further details of the emission driver of FIG. 5.

Referring to FIGS. 2 and 9, the emission driver 123 according to some embodiments of the present disclosure may include a plurality of stages EST for supplying respective emission control signals to the plurality of emission control lines EL1 to ELm.

In accordance with embodiments, the emission driver 123 may include a plurality of stages EST that are dependently connected to input terminals (i.e., the first input terminal 101 of the first stage EST1) of the emission start signal EFLM, such as first to fourth stages EST1 to EST4.

In FIG. 9, only four stages are shown, for example, the first to fourth stages EST1 to EST4.

The first to fourth stages EST1 to EST4 may be connected to any one of the first sub-gate lines EL1 to EL4 and may be driven in response to the first clock signal ECLK1, the second clock signal ECLK2. The first to fourth stages EST1 to EST4 may sequentially output emission control signals to the emission control lines EL1 to EL4. According to some embodiments, first to fourth stages EST1 to EST4 may have the same (or substantially the same) circuit structure as each other.

Each of the first to fourth stages EST1 to EST4 may include a first input terminal 101, a second input terminal 102, a third input terminal 103, and an output terminal 104.

The first input terminal 101 may be supplied with a first input signal. According to some embodiments, the first input signal may be an emission start signal EFLM or an output signal of the previous stage (i.e., an emission control signal of the previous stage).

For example, the first stage (hereinafter, referred to as "first stage EST1") may be supplied with an emission start signal EFLM via the first input terminal 101, and each of the remaining stages EST may be supplied with the output signal of the previous stage via their respective first input terminals 101.

The emission start signal EFLM may periodically have a second gate voltage VGL1. The second gate voltage VGL1 may refer to the first low voltage VGL1 described in FIG. 5.

The second input terminal 102 and the third input terminal 103 may be supplied with a second input signal and a third input signal, respectively. According to some embodiments, the second input signal may be a first clock signal ECLK1 and the third input signal may be second clock signal ECLK2.

The first clock signal ECLK1 and the second clock signal ECLK2 may alternately have a second gate voltage VGL1. For example, the first clock signal ECLK1 and the second clock signal ECLK2 may be signals that have the same cycle period and phases thereof are not overlapped with each other. In one example, the second clock signal ECLK2 may be a clock signal in a form of the first clock signal ECLK1 shifted by half a cycle period.

Further, the first to fourth stages EST1 to SET4 may be driven by being supplied with the first gate voltage VGH and the second gate voltage VGL1. The first gate voltage VGH may be set to a gate-off voltage, e.g., a logic high level, and the second gate voltage VGL1 may be set to a gate-on voltage, e.g., a logic low level (when the pixels are formed with P-type transistors).

In this case, the first gate voltage VGH and the second gate voltage VLG1 delivered to the output terminal 104 may be used as emission control signals supplied to the sub-pixels SP of FIG. 1.

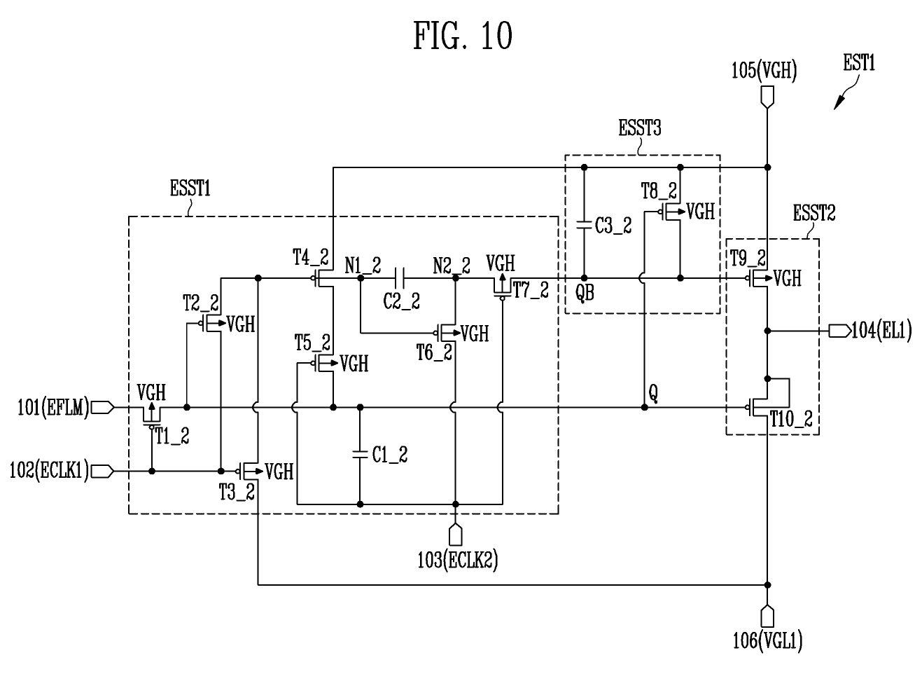

FIG. 10 illustrates the stage shown in FIG. 9. According to some embodiments, the plurality of stages forming the emission driver 123 may have the same (or substantially the same) circuit structure with each other. Accordingly, only the first stage EST1 is illustrated in FIG. 10 as representative of the stages. Although FIG. 10 illustrates various components in a stage according to some embodiments, embodiments according to the present disclosure are not limited thereto, and according to various embodiments the stage may include additional components, or fewer components, without departing from the spirit and scope of embodiments according to the present disclosure.

Referring to FIGS. 9 and 10, the first stage EST1 may include a node control unit EST1, an output section EST2, and a node maintaining unit (or node maintainer, or node maintaining circuit, or node maintaining component) SST3.

The first stage EST1 may generate an emission control signal using the first to third input signals supplied via the first to third input terminals 101 to 103 and supply the generated emission control signal to the output terminal 104.

Further, the first stage ST1 may be supplied with first and second gate voltages VGH, VGL1 via the first and second power supply terminals 105, 106, respectively. As such, the first stage ST1 may control the voltage at the output terminal 104 by using the first and second gate voltages VGH, VGL1 supplied to the first and second power supply terminals 105, 106.

The output unit EST2 is connected to the first power supply terminal 105 and the second power supply terminal 106, and the output unit EST2 may output the first gate voltage VGH and the second gate voltage VGL1 as emission control signals to the output terminal 104 based on the voltage of the second control node Q and the voltage of the first control node QB.

The output unit SST2 may include a ninth transistor T9_2 (or, a pull-up transistor) and a tenth transistor T10_2 (or, a pull-down transistor).

The ninth transistor T9_2 may include a first electrode connected to the first power supply terminal 105, a second electrode connected to the output terminal 104, and a gate electrode connected to the first control node QB.

The tenth transistor T10_2 may include a first electrode connected to the output terminal 104, a second electrode connected to the second power supply terminal 106, and a gate electrode connected to the second control node Q. Further, the first electrode of the tenth transistor T10_2 may be connected with a body electrode.

As the voltage difference between the body electrode and the source electrode (i.e., the first electrode) of the tenth transistor T10_2 becomes smaller, the phenomenon of the voltage of the tenth transistor T10_2 increasing may be prevented or reduced. That is, the driving power of the tenth transistor T10_2 may be relatively improved. Accordingly, the operation accuracy of the first stage EST1 may be relatively improved, the reliability may be improved, and the image quality of the display panel including pixels may be relatively improved.

The node control unit EST1 may be connected to the first input terminal 101, the second input terminal 102, the third input terminal 103, the first power supply terminal 105, and the second power supply terminal 106. The node control unit EST1 may control the voltage of the first control node QB and the voltage of the second control node Q by using the emission start signal (EFLM; or the emission control signal of the previous stage) provided via the first input terminal 101.

The node control unit EST1 may include first to seventh transistors T1_2 through T7_2, a first capacitor C1_2, and a second capacitor C2_2.

The first transistor T1_2 may include a first electrode connected to the first input terminal 101, a second electrode connected to the second control node Q, and a gate electrode connected to the second input terminal 102.

The second transistor T2_1 can include a first electrode connected to the first node N1_2, a second electrode connected to the second control node Q, and a gate electrode connected to the second control node Q.

The third transistor T3_2 may include a first electrode connected to the first node N1_2, a second electrode connected to the second power supply terminal 106, and a gate electrode connected to the second input terminal 102.

The fourth transistor T4_2 may include a first electrode connected to the first power supply terminal 105, a second electrode connected to the first electrode of the fifth transistor T5_2, and a gate electrode connected to the first node N1_2.

The fifth transistor T5_2 may include a first electrode connected to the second electrode of the fourth transistor T4_2, a second electrode connected to the second control node Q, and a gate electrode connected to the third input terminal 103.

The sixth transistor T6_2 may include a first electrode connected to the second node N2_2, a second electrode connected to the third input terminal 103, and a gate electrode connected to the first node N1_2.

The seventh transistor T7_2 may include a first electrode connected to the second node N2_2, a second electrode connected to the first control node QB, and a gate electrode connected to the third input terminal 103.

The first capacitor C1_2 may be connected between the second control node Q and the third input terminal 103, and the second capacitor C2_2 may be connected between the first node N1_2 and the second node N2_2.

The node maintaining unit EST3 may maintain the voltage of the first control node QB constant in response to the voltage of the second control node Q. The node maintaining unit EST3 may include a third capacitor C3_2 and an eighth transistor T8_2.

The eighth transistor T8_2 may include a first electrode connected to the first power supply terminal 105, a second electrode connected to the first control node QB, and a gate electrode connected to the second control node Q.

The third capacitor C3_2 may be connected between the first power supply terminal 105 and the first control node QB.

A first gate voltage VGH may be applied to the body electrode of each of the first to ninth transistors T1_2 to T9_2.

Each of the first to tenth transistors T1_2 to T10_2 may be a P-type transistor. Furthermore, according to some embodiments, at least one of the first to tenth transistors T1_2 to T10_2 may be implemented as a dual gate transistor for relatively improved reliability.

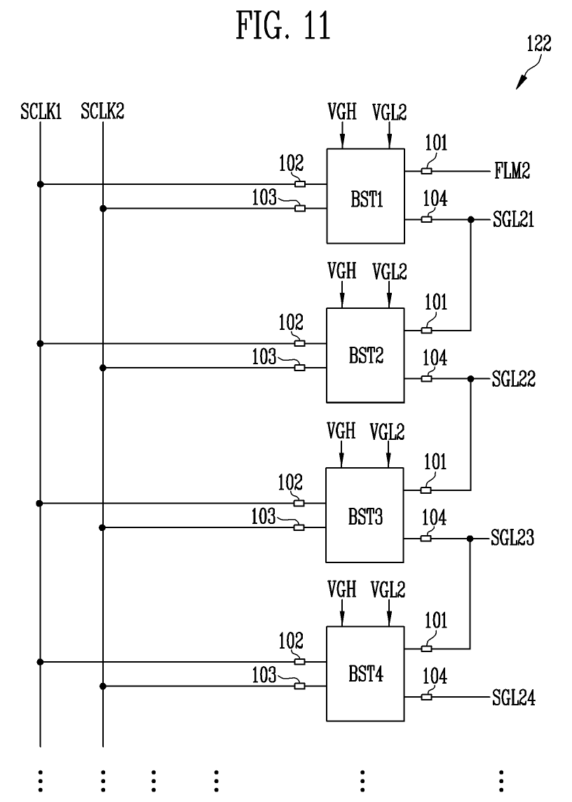

FIG. 11 is a block diagram illustrating further details of the second sub-gate driver of FIG. 5.

Referring to FIGS. 2 and 11, the second sub-gate driver 122 according to some embodiments of the present disclosure may include a plurality of stages BST for supplying respective second sub-gate signals to the plurality of second sub-gate lines SGL21 to SGL2m.

In accordance with embodiments, the second sub-gate driver 122 may include a plurality of stages BST, such as first to fourth stages BST1 to BST4, dependently connected to an input terminal (e.g., the first input terminal 101 of the first stage BST1) of the second start signal FLM2.

In FIG. 11, only four stages are shown, for example, the first to fourth stages BST1 to BST4.

The first to fourth stages BST1 to BST4 are coupled to any one of the second sub-gate lines SGL21 to SGL24 and may be driven in response to the first clock signal SCLK1 and the second clock signal SCLK2.

The first to fourth stages BST1 to BST4 may sequentially output the second sub-gate signals to the second sub-gate lines SGL21 to SGL24. According to some embodiments, the first to fourth stages BST1 to BST4 may have the same (or substantially the same) circuit structure as each other.

Each of the first to fourth stages BST1 to BST4 may include a first input terminal 101, a second input terminal 102, a third input terminal 103, and an output terminal 104.

The first input terminal 101 may be supplied with a first input signal. According to some embodiments, the first input signal may be a second start signal FLM2 or an output signal of the previous stage (i.e., a second sub-gate signal of the previous stage).

For example, the first stage (hereinafter, referred to as "first stage BST1") may be supplied with a second start signal FLM2 via the first input terminal 101, and the remaining stages BST may be supplied with the output signal of the previous stage via their respective first input terminals 101.

The second start signal FLM2 may periodically have a second gate voltage VGL1. The second gate voltage VGL1 may refer to the first low voltage VGL1 described in FIG. 5.

The second input terminal 102 and the third input terminal 103 may be supplied with a second input signal and a third input signal, respectively. According to some embodiments, the second input signal may be a first clock signal SCLK1 and the third input signal may be a second clock signal SCLK2.

The first clock signal SCLK1 and the second clock signal SCLK2 may alternately have a second gate voltage VGL1. For example, the first clock signal SCLK1 and the second clock signal SCLK2 may be signals that have the same cycle period and phases therefor are not overlapped with each other. For example, the second clock signal SCLK2 may be a clock signal in a form of the first clock signal SCLK1 shifted by half a cycle period.

Additionally, the first to fourth stages BST1 to BET4 may be driven by supplied with the first gate voltage VGH and second gate voltage VGL2. Unlike the first sub-gate driver 121 and the emission driver 123 of FIG. 5, the second gate voltage of the second sub-gate driver 122 may be a second low voltage VGL2.

The first gate voltage VGH may be set to a gate-off voltage, for example, a logic high level, and the second gate voltage VGL2 may be set to a gate-on voltage, for example, a logic low level (when the pixels are formed with P-type transistors). In this case, the first gate voltage VGH and the second gate voltage VLG2 delivered to the output terminal 104 may be used as second sub-gate signals supplied to the sub-pixels SP of FIG. 2.

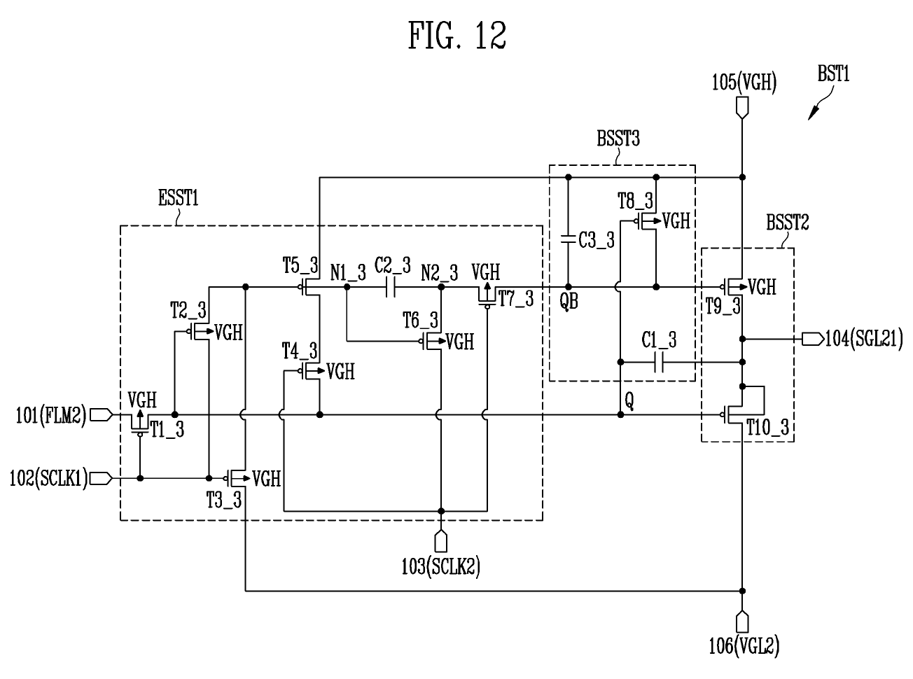

FIG. 12 illustrates the stage shown in FIG. 11. According to some embodiments, the plurality of stages forming the second sub-gate driver 122 may have the same (or substantially the same) circuit structure as each other. Accordingly, in FIG. 12, only the first stage BST1 is shown to represent these stages. Although FIG. 12 illustrates various components in a stage according to some embodiments, embodiments according to the present disclosure are not limited thereto, and according to various embodiments the stage may include additional components, or fewer components, without departing from the spirit and scope of embodiments according to the present disclosure.

Referring to FIGS. 11 and 12, the first stage BST1 may include a node control unit BSST1, an output unit BSST2, and a node maintaining unit BSST3.

The first stage BSST1 may generate a second sub-gate signal using the first to third signals supplied via the first to third input terminals 101 to 103 and supply the generated emission control signal to the output terminal 104.

Further, the first stage BSST1 may be supply with first and second gate voltages VGH, VGL2 via the first and second power supply terminals 105, 106, respectively. As such, the first stage BSST1 may control the voltage at the output terminal 104 by using the first and second gate voltages VGH, VGL2 supplied to the first and second power supply terminals 105, 106.

The output unit BSST2 is connected to the first power supply terminal 105 and the second power supply terminal 106, and the output unit BSST2 may output the first gate voltage VGH as a second sub-gate signal to the output terminal 104 based on the voltage of the second control node Q and the voltage of the first control node QB.

The output unit BSST2 may include a ninth transistor T9_3 (or, pull-up transistor) and a tenth transistor T10_3 (or, pull-down transistor).

The ninth transistor T9_3 may include a first electrode connected to the first power supply terminal 105, a second electrode connected to the output terminal 104, and a gate electrode connected to the first control node QB.

The tenth transistor T10_3 may include a first electrode connected to the output terminal 104, a second electrode connected to the second power supply terminal 106, and a gate electrode connected to the second control node Q. Further, the first electrode of the tenth transistor T10_3 may be connected with a body electrode.

As the voltage difference between the body electrode and the source electrode (i.e., the first electrode) of the tenth transistor T10_3 becomes smaller, the phenomenon that the threshold voltage of the tenth transistor T10_3 increases may be prevented or reduced. In other words, the driving power of the tenth transistor T10_3 may be relatively improved. Accordingly, the operation accuracy of the first stage BST1 may be relatively improved, the reliability may be relatively improved, and the image quality of the display panel including pixels may be relatively improved.

The node control unit BSST1 may be connected to the first input terminal 101, the second input terminal 102, the third input terminal 103, the first power supply terminal 105, and the second power supply terminal 106. The node control unit EST1 may control the voltage of the first control node QB and the voltage of the second control node Q using the second start signal (FLM2; or, the second sub-gate signal of the previous stage) provided via the first input terminal 101.

The node control unit BSST1 may include first to seventh transistors T1_3 to T7_3, and a second capacitor C2_3.

The first transistor T1_3 may include a first electrode connected to the first input terminal 101, a second electrode connected to the second control node Q, and a gate electrode connected to the second input terminal 102.

The second transistor T2_3 may include a first electrode connected to the first node N1_3, a second electrode connected to the second input terminal 102, and a gate electrode connected to the second control node Q.

The third transistor T3_3 may include a first electrode connected to the first node N1_3, a second electrode connected to the second power supply terminal 106, and a gate electrode connected to the second input terminal 102.

The fourth transistor T4_3 may include a first electrode connected to a second electrode of the fifth transistor T5_3, a second electrode connected to the second control node Q, and a gate electrode connected to the third input terminal 103.

The fifth transistor T5_3 may include a first electrode connected to the first power supply terminal 105, a second electrode connected to the first electrode of the fourth transistor T4_3, and a gate electrode connected to the first node N1_3.

The sixth transistor T6_3 may include a first electrode connected to the second node N2_3, a second electrode connected to the third input terminal 103, and a gate electrode connected to the first node N1_3.

The seventh transistor T7_3 may include a first electrode connected to the second node N2_3, a second electrode connected to the first control node QB, and a gate electrode connected to the third input terminal 103.

The second capacitor C2_3 may be connected between the first node N1_3 and the second node N2_3.

The node maintaining unit BSST3 may maintain a constant voltage on the first control node QB in response to a voltage on the second control node Q. The node maintaining unit BSST3 may include a first capacitor C1_3, a third capacitor C3_3, and an eighth transistor T8_3.

The eighth transistor T8_3 may include a first electrode connected to the first power supply terminal 105, a second electrode connected to the first control node QB, and a gate electrode connected to the second control node Q.

The first capacitor C1_3 may be connected between the second control node Q and the output terminal 104, and the third capacitor C3_3 may be connected between the first power supply terminal 105 and the first control node QB.

A first gate voltage VGH may be applied to the body electrode of each of the first to ninth transistors (T1_3 to T9_3).

Each of the first to tenth transistors T1_3 to T10_3 may be a P-type transistor. Furthermore, according to some embodiments, at least one of the first to tenth transistors T1_3 to T10_3 may be implemented as a dual gate transistor for relatively improved reliability.

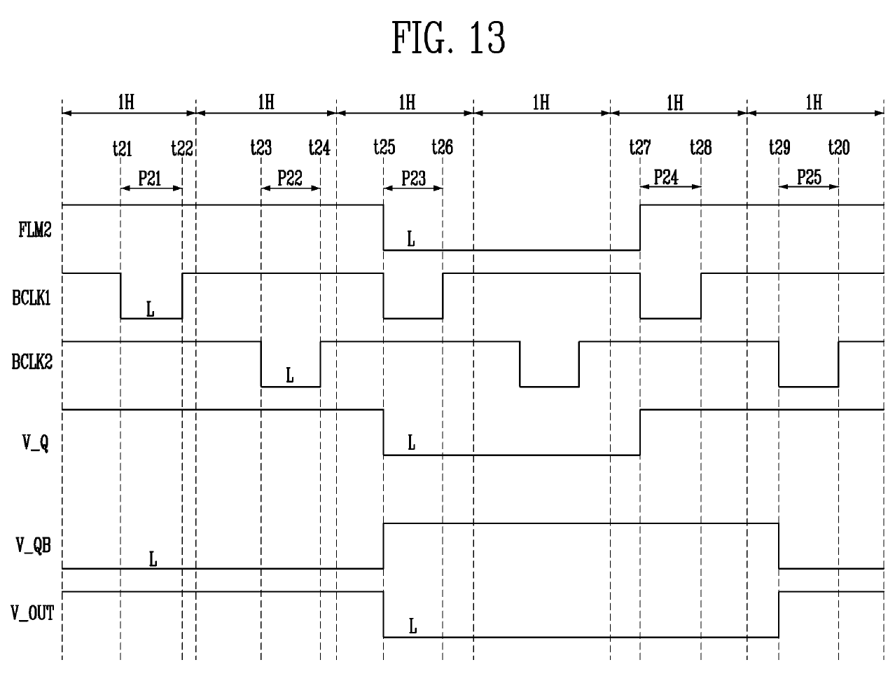

FIG. 13 is a waveform diagram illustrating one example of measured signals at the first stage of FIG. 12.

Referring to FIGS. 12 and 13, the measured signals at the first stage BSST1 are shown. A first clock signal SCLK1 applied to the second input terminal 102 has a cycle period of two horizontal periods 2H and may have a logic low level and a logic high level. Here, the logic low level may refer to the first low voltage VGL1 shown in FIG. 5 that turns on the P-type transistor. The logic high level may be equal to the first gate voltage VGH level that turns the P-type transistor off.

According to some embodiments, the logic level of each of the first clock signal SCLK1, the second clock signal SCLK2, and the second start signal FLM2 may be greater than the voltage level of the second gate voltage VGL2 applied to the first stage BSST1 as the first low voltage VGL1.

The second clock signal SCLK2 applied to the third input terminal 103 may have a waveform such as the first clock signal SCLK1 is delayed by half a cycle period (i.e., by one horizontal period 1H).

During first period P21 between first time point t21 and the second time point t22, the first clock signal SCLK1 may have a logic low level, and the second start signal FLM2 and the second clock signal SCLK2 may have a logic high level.

Further, in the first period P21, the second node voltage V_Q at the second control node Q may have a logic high level, the first node voltage V_QB at the first control node QB may have a logic low level, and the output voltage V_OUT (i.e., the second sub-gate signal) at the output terminal 104 may have a logic high level.

At the second time point t22, the first clock signal SCLK1 may change from a logic low level to a logic high level. The second clock signal SCLK2 and the second start signal FLM2 may remain at a logic high level.

At a third time point t23, the second clock signal SCLK2 may change from a logic high level to a logic low level. The first clock signal SCLK1 and the second start signal FLM2 may remain at a logic high level.

During the second period P22 between the third time point t23 and the fourth time point t24, the second clock signal SCLK2 may have a logic low level, the second start signal FLM2 and the first clock signal SCLK1 may have a logic high level.

Further, in the second period P22, the second node voltage V_Q at the second control node Q may have a logic high level, the first node voltage V_QB at the first control node QB may have a logic low level, and the output voltage V_OUT (i.e., the second sub-gate signal) at the output terminal 104 may have a logic high level.

At the fourth time point (t24), the second clock signal SCLK2 may change from a logic low level to a logic high level. The first clock signal SCLK1 and the second start signal FLM2 may remain at a logic high level.

At the fifth time point t25, the second start signal FLM2 and the first clock signal SCLK1 may change from a logic high level to a logic low level. The second clock signal SCLK2 may remain at a logic high level.

During third period P23 between the fifth time point t25 and the sixth time point t26, the second start signal FLM2 and the first clock signal SCLK1 may have a logic low level and the second clock signal SCLK2 may have a logic high.

Further, in the third period P23, the second node voltage V_Q at the second control node Q may have a logic low level, the first node voltage V_QB at the first control node QB may have a logic high level, and the output voltage V_OUT (i.e., the second sub-gate signal) at the output terminal 104 may have a logic low level.

At the seventh time point t27, the second start signal FLM2 may change from a logic low level to logic high level, and the first clock signal SCLK1 may change from a logic high level to a logic low level. The second clock signal SCLK2 may remain at a logic high level.

During the period between the fifth time point t25 and the seventh time point t27, the second start signal FLM2 and the second node voltage V_Q may remain at a logic low level.

The fourth period P24 between the seventh time point t27 and the eighth time point t28 may be a similar period with the first period P21.

At a ninth time point t29, the second clock signal SCLK2 may change from a logic high level to a logic low level.

During the period between the fifth time point t25 and the ninth time point t29, the first node voltage V_QB may remain at a logic high level and the output voltage V_OUT (i.e., the second sub-gate signal) may remain at a logic low level.

The fifth period P25 between the ninth time point t29 and the tenth time point t20 may be a similar period to the second period P22.

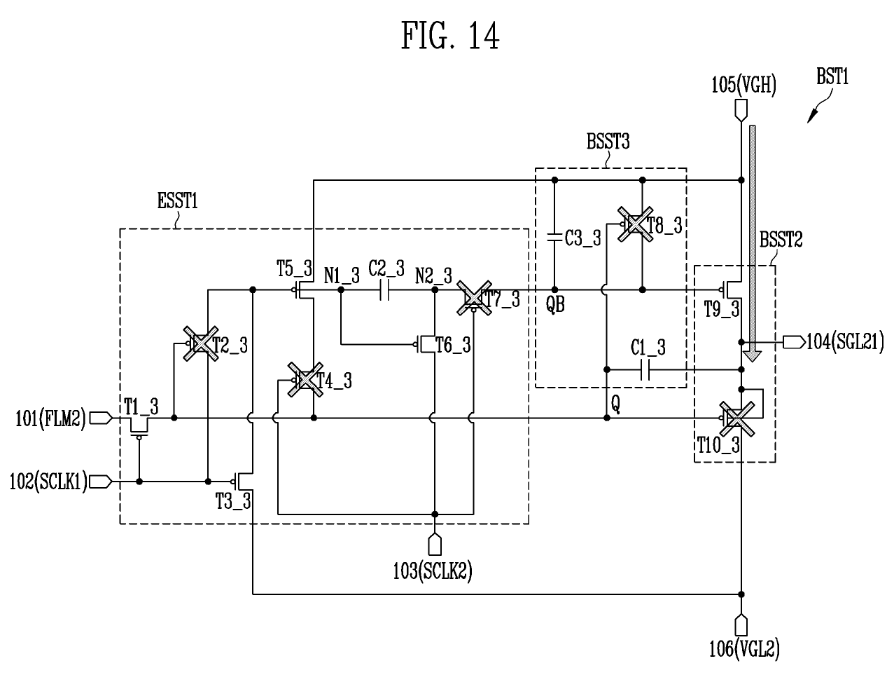

FIGS. 14 through 16 are circuit diagrams illustrating operation of the first stage in response to the signals of FIG. 13.

For ease of explanation, the diagrams in which the first gate voltage VGH is applied to the body electrodes of each of the first to ninth transistors T1_3 to T9_3 may be omitted.

Referring to FIG. 14, during first period P21, first clock signal SCLK1 may have a logic low level, and the second start signal FLM2 and the second clock signal SCLK2 may have a logic high level.

In this case, the first transistor T1_3, and the third transistor T3_3 may be turned on in response to a first clock signal SCLK1 having a logic low level, and the second transistor T2_3, the eighth transistor T8_3, and the tenth transistor T10_3 may be turned off in response to a second start signal FLM2 having a logic high level.

In addition, in response to a second clock signal SCLK2 having a logic high level, the fourth transistor T4_3, and the seventh transistor T7_3 may be turned off.

Accordingly, the second gate voltage VGL2 can be supplied to the first node N1_3 through the third transistor T3_3, the first control node QB can be maintained in its previous state (logic low level) by the third capacitor C3_3, and the ninth transistor T9_3 can be turned on so that the first gate voltage VGH may be applied to the output terminal 104, i.e., the output voltage V_OUT can have a logic high level.

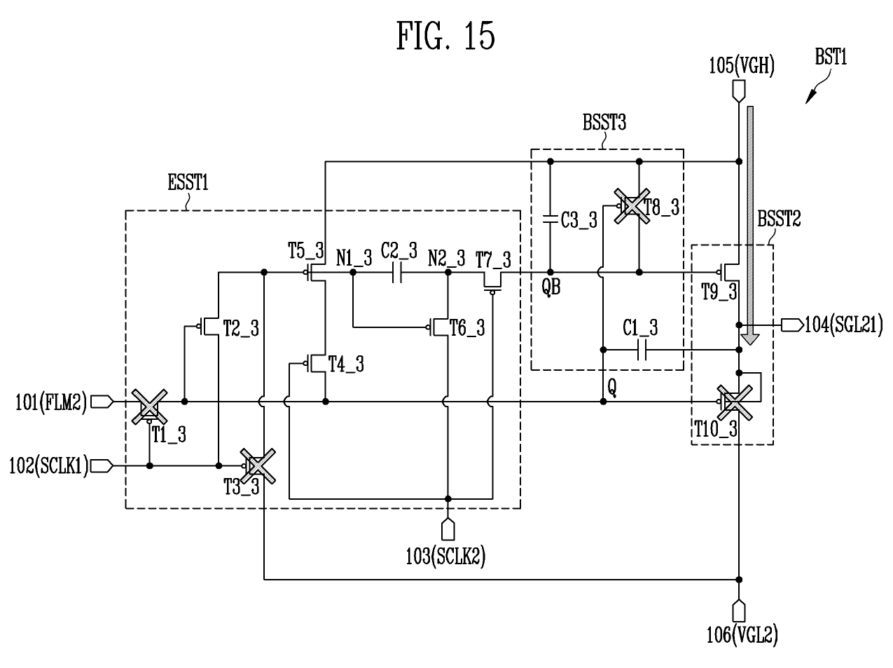

Referring to FIG. 15, during second period P22, the second clock signal SCLK2 may have a logic low level, and the second start signal FLM2 and the first clock signal SCLK1 may have a logic high level.

In this case, the fourth transistor T4_3, and the seventh transistor T7_3 may be turned on in response to the second clock signal SCLK2 having a logic low level, and the first transistor T1_3, and the third transistor T3_3 may be turned off in response to the first clock signal SCLK1 having logic high level.

The sixth transistor T6_3 is turned on by the first node N1_3 having a logic low level, and accordingly, the first control node QB may receive a second clock signal SCLK2 having a logic low level through the seventh transistor T7_3. The ninth transistor T9_3 may be turned on so that a first gate voltage VGH may be applied to the output terminal 104, i.e., the output voltage V_OUT may have a logic high level.

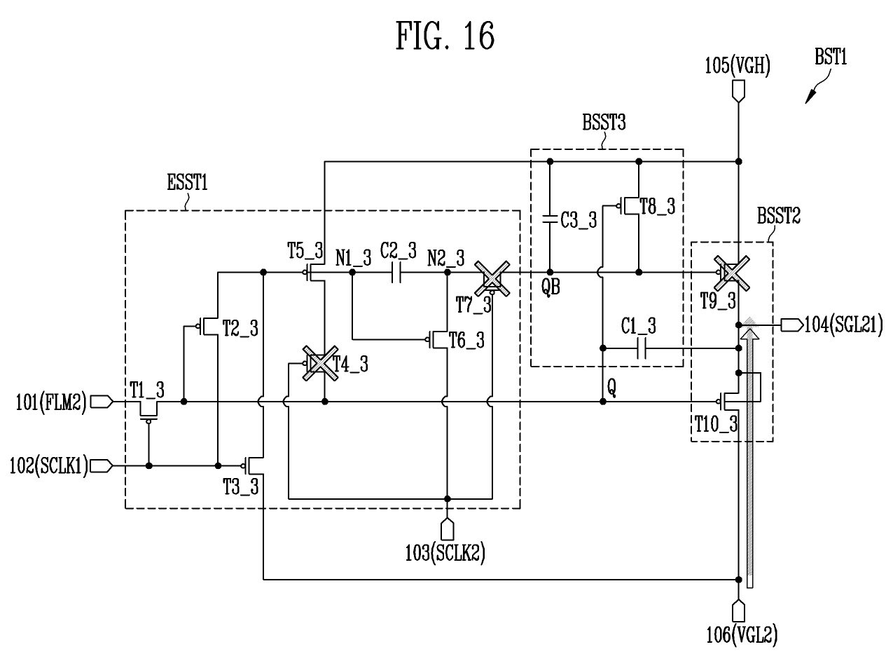

Referring to FIG. 16, during third period P23, first clock signal SCLK1 and second start signal FLM2 may have a logic low level and the second clock signal SCLK2 may have a logic high level.

In this case, the first transistor T1_3, and the third transistor T3_3 may be turned on in response to the first clock signal SCLK1 having logic low level, and the second transistor T2_3, the eighth transistor T8_3, and the tenth transistor T10_3 may be turned on in response to the second start signal FLM2 having a logic low level.

Accordingly, the first control node QB may be supplied with the first gate voltage VGH and the ninth transistor T9_3 may be turned off. The voltage of the second control node Q may be maintained at a logic low level by the first capacitor C1_3. The tenth transistor T10_3 may be turned on so that the second gate voltage VGL2 may be applied to the output terminal 104, i.e., the output voltage V_OUT may have a logic low level.

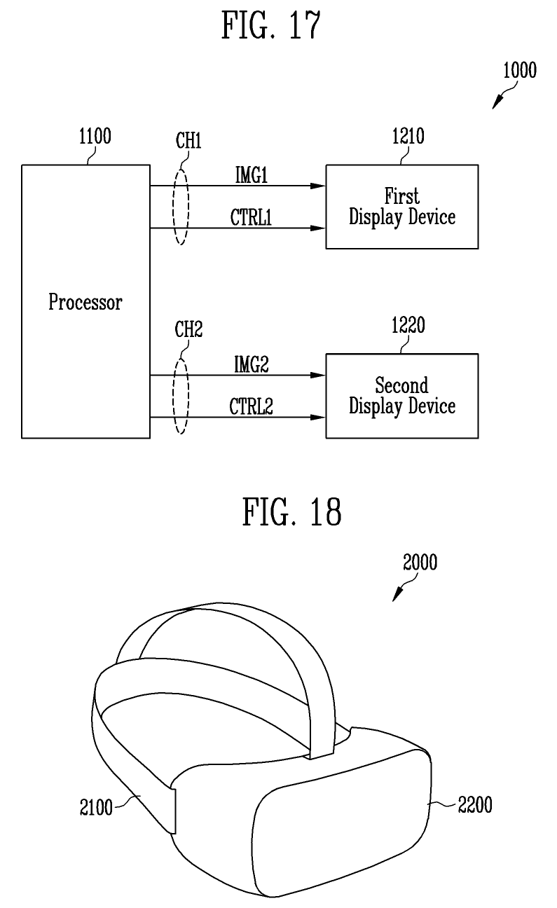

FIG. 17 is a block diagram illustrating further details of the display system.

Referring to FIG. 17, the display system 1000 may include a processor 1100 and one or more display devices 1210, 1220.

The processor 1100 can perform a variety of tasks and calculations. According to some embodiments, the processor 1100 may include an application processor, a graphics processor, a microprocessor, a central processing unit (CPU), or the like. The processor 1100 may be connected to other components of the display system 1000 via a bus system to control them.

In FIG. 17, a display system 1000 is shown to include first and second display devices 1210, 1220. The processor 1100 may be coupled to the first display device 1210 via a first channel CH1 and to the second display device 1220 via a second channel CH2.

Over the first channel CH1, the processor 1100 may transmit the first image data IMG1 and the first control signal CTRL1 to the first display device 1210. The first display device 1210 may display the image based on the first image data IMG1 and the first control signal CTRL1. The first display device 1210 may be configured similarly to the display device 100 described with reference to FIG. 2. In such a case, the first image data IMG1 and the first control signal CTRL1 may be provided as the input image data IMG and control signal CTRL of FIG. 1, respectively.

Through the second channel CH2, the processor 1100 may transmit the second image data IMG2 and the second control signal CTRL2 to the second display device 1220. The second display device 1220 may display the image based on the second image data IMG2 and the second control signal CTRL2. The second display device 1220 may be configured like the display device 100 described with reference to FIG. 2. In such a case, the second image data IMG2 and the second control signal CTRL2 may be provided as the input image data IMG and control signal CTRL of FIG. 1, respectively.

As the first display device 1210 and the second display device 1220 are configured similarly to the display device 100 described with reference to FIG. 2, the accuracy and reliability of operation of the display system 1000 may be relatively improved, and the image quality of the display panel containing the pixels may be relatively improved.

The display system 1000 may include a portable computer, mobile phone, smart phone, tablet personal computer, and computing system providing video display capabilities such as a smart watch, watch phone, portable multimedia player (PMP), navigation, ultra mobile personal computer (UMPC), and the like. The display system 1000 may also include at least one of a head-mounted display (HMD), a virtual reality (VR) device, a mixed reality (MR) device, or an augmented reality (AR) device.

FIG. 18 is a perspective view showing further details of the display system of FIG. 17.

Referring to FIG. 18, the indication system 1000 of FIG. 17 may be applied to a head-mounted display device 2000. The head-mounted display device 2000 may be a wearable display system that can be worn on a user's head.

A head-mounted display device 2000 may include a head-mounted band 2100 and a display device storage case 2200. The head-mounted band 2100 may be connected to the display device storage case 2200. The head mounting band 2100 may include a horizontal band and/or a vertical band for securing the head-mounted display device 2000 to the head of a user. The horizontal band may be configured to wrap around a side portion of the user's head, and the vertical band may be configured to wrap around a top portion of the user's head. However, embodiments are not limited to these. For example, the head-mounted band 2100 may be implemented in the form of an eyeglass frame, a helmet, or the like.

The display device storage case 2200 can house the first and second display devices 1210, 1220 of FIG. 17. The display device storage case 2200 can further house the processor 1100 of FIG. 17.

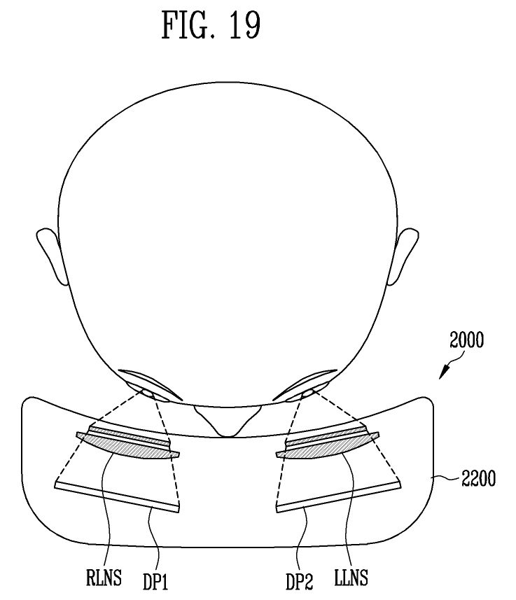

FIG. 19 is a diagram illustrating a head-mounted display device worn on the user of FIG. 18.

Referring to FIG. 19, a first display panel DP1 of a first display device 1210 and a second display panel DP2 of a second display device 1220 are located within a head-mounted display device 2000. The head-mounted display device 2000 may further include one or more lenses LLNS, RLNS.

Within the display device storage case 2200, the right lens RLNS may be located between the first display panel DP1 and the user's right eye. Within the display device storage case 2200, the left eye lens LLNS may be located between the second display panel DP2 and the user's left eye.

The image output from the first display panel DP1 may be displayed to the user's right eye through the right lens of the right eye lens RLNS. The right eye lens RLNS may refract light from the first display panel DP1 to be directed to the user's right eye. The right eye lens RLNS may perform an optical function for adjusting the viewing distance between the first display panel DP1 and the user's right eye.

The image output from the second display panel DP2 may be displayed to the user's left eye through a left lens LLNS. The left eye lens LLNS may refract light from the second display panel DP2 to be directed toward the user's left eye. The left eye lens LLNS may perform an optical function to adjust the viewing distance between the second display panel DP2 and the user's left eye.

According to some embodiments, each of the right lens RLNS and the left lens LLNS may include an optical lens having a pancake-shaped cross-section. According to some embodiments, each of the right eye lens RLNS and the left eye lens LLNS may include a multi-channel lens including sub-regions having different optical properties. In such cases, each display panel may output images corresponding to each of the sub-areas of the multi-channel lens, and the output images may pass through each of the sub-areas to be displayed to the user.

The display device according to some embodiments can be applied to various electronic devices. The electronic device according to some embodiments comprises the display device described above and may further comprise modules or devices having other additional functions in addition to the display device.

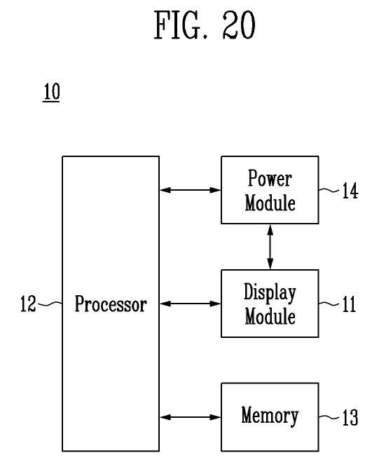

FIG. 20 is a block diagram of an electronic device, according to some embodiments. Referring to FIG. 20, the electronic device 10 according to some embodiments may include a display module 11, a processor 12, a memory 13, and a power module 14.

The processor 12 may include at least one of a central processing unit (CPU), an application processor (AP), a graphics processing unit (GPU), a communication processor (CP), an image signal processor (ISP), or a controller.

The memory 15 may store data information necessary for operation of the processor 12 or the display module 11. When the processor 12 executes an application stored in the memory 15, image data signals and/or input control signals are delivered to the display module 11, and the display module 11 may process the received signals to output image information via the display screen.

The power module 14 may include a power supply module, such as a power adapter or battery unit, and a power conversion module that converts power supplied by the power supply module to generate power required for operation of the electronic device 10.

At least one of each of the above-described configurations of the electronic device 10 may be included within the display device according to the above-described embodiments. Furthermore, some of the individual modules that are functionally contained within one module may be included within the display device and others may be provided separately from the display device. For example, the display device may include a display module 11, while the processor 12, memory 13, and power module 14 may be provided in the form of other devices within the electronic device 10 other than the display device.

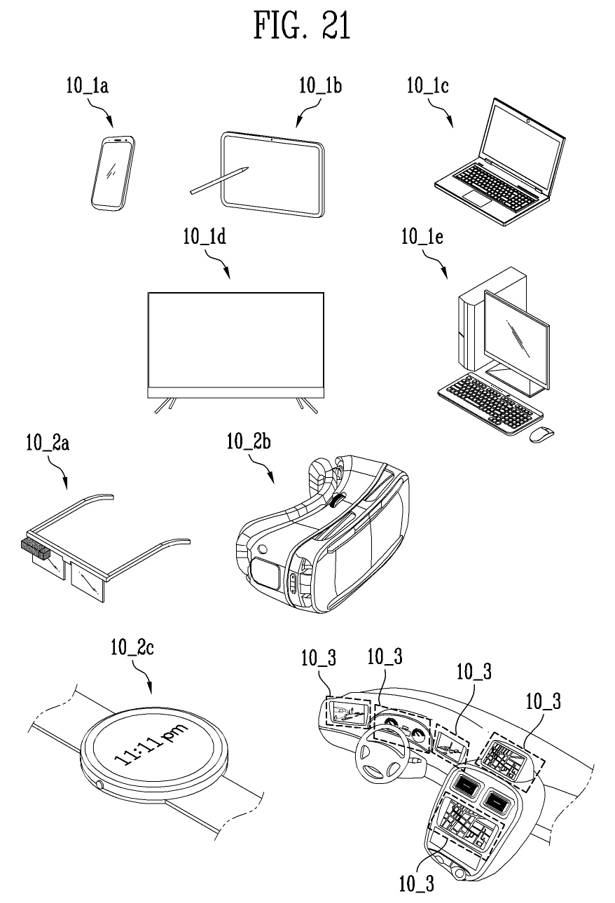

FIG. 21 is a schematic diagram of an electronic device according to various embodiments.

Referring now to FIG. 21, various electronic devices applied with display devices according to some embodiments may include electronic devices for displaying images such as smartphones 10_1a, tablet PCs 10_1b, laptops 10_1c, televisions 10_1d, desk monitors 10_1e, and the like, wearable electronic devices including display modules such as smart glasses 10_2a, head-mounted displays 10_2b, smart watches 10_2c, and the like, and automotive electronic devices 10_3 including display modules such as a dashboard of an automobile, center fascia, center information displays CIDs located at a dashboard, room mirror displays, and the like.

Although aspects of some embodiments and applications have been described herein, other and may be from the above Accordingly, the spirit and scope of embodiments according to the present disclosure is not limited to these embodiments, but extends to the patent claims set forth below, various obvious variations, and equivalents.

According to some embodiments of the disclosure, the stage, the display device including the same, and the display system including the same may implement a sub-pixel by using transistors (e.g., MOSFETs) suitable for black grayscale representation.

In addition, the operation accuracy and reliability of the display device may be relatively improved, and the image quality of the display panel including the pixels may be relatively improved.

However, the characteristics of embodiments according to the present disclosure are not limited to the effects described above and may be extended in various ways without departing from the spirit and scope of embodiments according to the present disclosure.

What is claimed is:

1. A stage comprising:
a node control unit configured to control a voltage of a first control node and a voltage of a second control node in response to a first input signal, a second input signal, and a third input signal;
a node maintaining unit configured to maintain a voltage of the first control node and a voltage of the second control node constant; and
an output unit configured to supply, based on a voltage of the first control node and a voltage of the second control node, a first gate voltage supplied to a first power supply terminal or a second gate voltage supplied to a second power supply terminal to an output terminal,
wherein a logic low level of each of the first input signal, the second input signal, and the third input signal is greater than a voltage level of the second gate voltage.

2. The stage of claim 1,
wherein the output unit comprises a pull-down transistor comprising a first electrode connected to the output terminal, a second electrode connected to the second power supply terminal, a gate electrode connected to the second control node, and a body electrode connected to the first electrode.

3. The stage of claim 2,
wherein the node maintaining unit comprises a first capacitor connected between the second control node and the output terminal.

4. The stage of claim 3,
wherein the first input signal is configured to be supplied to a first input terminal, the second input signal is configured to be supplied to the output terminal 104, and the third input signal is configured to be supplied to a third input terminal, and
wherein the node control unit comprises,
a first transistor comprising a first electrode connected to the first input terminal, a second electrode connected to the second control node, and a gate electrode connected to the output terminal (104);
a second transistor comprising a first electrode connected to a first node, a second electrode connected to the second input terminal, and a gate electrode connected to a second control node;
a third transistor comprising a first electrode connected to the first node, a second electrode connected to the second power supply terminal, and a gate electrode connected to the second input terminal;
a fourth transistor comprising a first electrode connected to a second electrode of the fifth transistor, a second electrode connected to the second control node, and a gate electrode connected to the third input terminal;
a fifth transistor comprising a first electrode connected to the first power supply terminal, a second electrode connected to the first electrode of the fourth transistor, and a gate electrode connected to the first node;
a sixth transistor comprising a first electrode connected to a second node, a second electrode connected to the third input terminal, and a gate electrode connected to the first node;
a seventh transistor comprising a first electrode connected to the second node, a second electrode connected to the first control node, and a gate electrode connected to the third input terminal; and
a second capacitor connected between the first node and the second node.

5. The stage of claim 4,
wherein the node maintaining unit further comprises,
an eighth transistor comprising a first electrode connected to the first power supply terminal, a second electrode connected to the first control node, and a gate electrode connected to the second control node; and
a third capacitor connected between the first power supply terminal and the first control node.

6. The stage of claim 5,
wherein the output unit further comprises,
a pull-up transistor comprising a first electrode connected to the first power supply terminal, a second electrode connected to the output terminal, and a gate electrode connected to the first control node.

7. The stage of claim 6,
wherein each of the first transistor to the eighth transistor, the pull-up transistor, and the pull-down transistor is a MOSFET comprising a body electrode.

8. A display device comprising:
sub-pixels connected to first sub-gate lines, second sub-gate lines, and emission control lines;
a first sub-gate driver comprising a plurality of stages configured to supply a first sub-gate signal to the first sub-gate lines;
a second sub-gate driver comprising a plurality of stages configured to supply a second sub-gate signal to the second sub-gate lines, in response to the first input signal, the second input signal, and the third input signal; and
an emission driver comprising a plurality of stages configured to supply an emission control signal to the emission control lines,
wherein a logic low level of each of the first input signal, the second input signal, and the third input signal is greater than a voltage level of a second gate voltage supplied to the second sub-gate driver.

9. The display device of claim 8,
wherein a first gate voltage supplied to the first sub-gate driver, the second sub-gate driver, and the emission driver is same, and
wherein a voltage level of a second gate voltage supplied to the first sub-gate driver and the emission driver is greater than a voltage level of the second gate voltage supplied to the second sub-gate driver.

10. The display device of claim 9,
wherein a logic low level of each of the first input signal, the second input signal, and the third input signal is equal to a voltage level of a second gate voltage supplied to the first sub-gate driver and the emission driver.

11. The display device of claim 8,
wherein each of the stages of the second sub-gate driver comprises,
a node control unit configured to control a voltage of a first control node and a voltage of a second control node in response to the first input signal, the second input signal, and the third input signal;
a node maintaining unit configured to maintain a voltage of the first control node and a voltage of the second control node constant; and
an output unit configured to supply, in response to a voltage of the first control node and a voltage of the second control node, a first gate voltage supplied to the first power supply terminal or a second gate voltage supplied to the second power supply terminal to an output terminal,
wherein the output unit comprises a first pull-down transistor comprising a first electrode connected to the output terminal, a second electrode connected to the second power supply terminal, a gate electrode connected to the second control node, and a body electrode connected to the first electrode.

12. The display device of claim 11,
wherein the node maintaining unit comprises a first capacitor connected between the second control node and the output terminal.

13. The display device of claim 12,
wherein each of the stages of the first sub-gate driver comprises,
a node control unit configured to control, in response to a first start signal, a first clock signal, and a second clock signal, a voltage of a first control node and a voltage of a second control node; and
a second pull-down transistor comprising a first electrode connected to an output terminal from which the first sub-gate signal is output, a second electrode connected to an input terminal from which the first clock signal is supplied, a gate electrode connected to a second control node from which the first start signal is supplied, and a body electrode connected to the first electrode.

14. The display device of claim 13,
wherein each of the stages of the emission driver comprises,
a node control unit configured to control, in response to an emission start signal, a first emission clock signal, and a second emission clock signal, a voltage of a first control node and a voltage of a second control node; and
a third pull-down transistor comprising a first electrode connected to an output terminal from which the emission control signal is output, a second electrode connected to a power supply terminal from which the second gate voltage is supplied, a gate electrode connected to a second control node from which the emission start signal is supplied, and a body electrode connected to the first electrode.

15. The display device of claim 12,
wherein the first input signal is supplied to a first input terminal, the second input signal is supplied to a second input terminal, and the third input signal is supplied to a third input terminal, and
wherein the node control unit comprises,
a first transistor comprising a first electrode connected to the first input terminal, a second electrode connected to the second control node, and a gate electrode connected to the second input terminal;
a second transistor comprising a first electrode connected to a first node, a second electrode connected to the second input terminal, and a gate electrode connected to a second control node;
a third transistor comprising a first electrode connected to the first node, a second electrode connected to the second power supply terminal, and a gate electrode connected to the second input terminal;
a fourth transistor comprising a first electrode connected to a second electrode of a fifth transistor, a second electrode connected to the second control node, and a gate electrode connected to the third input terminal;
the fifth transistor comprising a first electrode connected to the first power supply terminal, a second electrode connected to the first electrode of the fourth transistor, and a gate electrode connected to the first node;
a sixth transistor comprising a first electrode connected to a second node, a second electrode connected to the third input terminal, and a gate electrode connected to the first node;
a seventh transistor comprising a first electrode connected to the second node, a second electrode connected to the first control node, and a gate electrode connected to the third input terminal; and
a second capacitor connected between the first node and the second node.

16. The display device of claim 15,
wherein the node maintaining unit further comprises,
an eighth transistor comprising a first electrode connected to the first power supply terminal, a second electrode connected to the first control node, and a gate electrode connected to the second control node; and
a third capacitor connected between the first power supply terminal and the first control node.

17. The display device of claim 16,
wherein the output unit further comprises,
a pull-up transistor comprising a first electrode connected to the first power supply terminal, a second electrode connected to the output terminal, and a gate electrode connected to the first control node.

18. The display device of claim 17,
wherein each of the first transistor to the eighth transistor, the pull-up transistor, and the first pull-down transistor is a MOSFET comprising a body electrode.

19. A display system comprising:
a processor configured to output image data and a control signal;
a display device configured to display an image based on the image data and the control signal,
wherein the display device comprises:
sub-pixels connected to first sub-gate lines, second sub-gate lines, and emission control lines;
a first sub-gate driver comprising a plurality of stages configured to supply a first sub-gate signal to the first sub-gate lines;
a second sub-gate driver comprising a plurality of stages configured to supply a second sub-gate signal to the second sub-gate lines in response to the first input signal, the second input signal, and the third input signal; and
an emission driver comprising a plurality of stages configured to supply an emission control signal to the emission control lines,
wherein a logic low level of each of the first input signal, the second input signal, and the third input signal is greater than a voltage level of a second gate voltage supplied to the second sub-gate driver.

20. The display system of claim 19,
wherein each of the stages of the second sub-gate driver comprises,
a node control unit configured to control a voltage of a first control node and a voltage of a second control node in response to the first input signal, the second input signal, and the third input signal;
a node maintaining unit configured to maintain a voltage of the first control node and a voltage of the second control node constant; and
an output unit configured to supply, in response to a voltage of the first control node and a voltage of the second control node, a first gate voltage supplied to a first power supply terminal or a second gate voltage supplied to a second power supply terminal to an output terminal,
wherein the output unit comprises a pull-down transistor comprising a first electrode connected to the output terminal, a second electrode connected to the second power supply terminal, a gate electrode connected to the second control node, and a body electrode connected to the first electrode.
